(19) United States
(12) Patent Application Publication
(10) Pub. No.: US 2026/0212841 A1
(43) Pub. Date: Jul. 23, 2026

(54) MODULAR CUSTOMIZABLE ERGONOMIC HOLDING DEVICE

(71) Applicant: Richard Robert Lewis, Truxton, NY (US)

(72) Inventor: Richard Robert Lewis, Truxton, NY (US)

(21) Appl. No.: 19/451,241

(22) Filed: Jan. 16, 2026

Related U.S. Application Data
(60) Provisional application No. 63/746,958, filed on Jan. 18, 2025.

(51) Int. Cl. G10D 3/173

(52) U.S. Cl. CPC G10D 3/173

(57) ABSTRACT

A holding device includes a body extending from a first end to a second end, a first interface at the first end, a top edge and an opposing bottom edge. A first side is bounded by the first interface, the second end, the top edge, and the bottom edge and includes a first surface portion. A second side opposes the first side and is bounded by the first interface, the second end, the top edge and the bottom edge and includes a second surface portion. A depression is defined at each of the first and second surface portions. A finger grip extends between the first side and the second side and is positioned towards the bottom edge. The first interface is configured to removably couple to an accessory. The depression and finger grip are configured to facilitate gripping of the body by a user's hand to securely operate the accessory.

### CROSS-REFERENCE TO RELATED APPLICATION

This application claims priority to, and the benefit of, U.S. Provisional Patent Application Ser. No. 63/746,958, filed on Jan. 18, 2025, and entitled “TRI-CONTACT MODULAR CUSTOMIZABLE ERGONOMIC PLECTRUM.” The entire contents of said application are hereby incorporated by reference.

### FIELD OF THE INVENTION

The present disclosure is directed to embodiments of an ergonometric holding device that may be used by a musician to contact the strings of an instrument to produce desired sounds, and particularly to a modular plectrum that is grasped by fingers. In specific terms, aspects of the present disclosure are directed to a multifunctional holding device that: (1) has three areas that can be used to contact instrument strings, (2) has a highly ergonomic design to minimize slippage, and (3) has a modular and customizable system for its major components. The present disclosure is further directed to a multifunctional holding device or holding assembly that assists the user in gripping or holding an object.

### BACKGROUND OF THE INVENTION

Devices, such as plectrums, have a long history of use by musicians playing any of the various stringed instruments in the general style of guitars, mandolins, and ukuleles. They are commonly referred to as “picks”, and future discussions will use the two terms interchangeably. They are employed to contact the strings of the instrument thereby effecting vibrations in the strings which produce desired musical sounds. As such, they are the primary alternative to using fingers to engage with the strings of an instrument, a technique referred to as finger picking or finger strumming. Over the years many different types of plectrums have been developed to suit musical needs and preferences, such that they now exhibit a wide range in attributes such as size, shape, thickness, ergonomic design, number of striking surfaces, and material composition.

### Conventional Flat Pick: Gripping Portion And Striker

Current or conventional flat picks or plectrums, being the archetypal form of the pick that is still common today, suffer from several problems.

We need to differentiate between those plectrums intended to be temporarily attached to the finger of a musician during play, known as finger picks and thumb picks, and those intended to be grasped by the fingers during use. The disclosed embodiments fit into the latter category.

As illustrated in FIG. 1, a conventional flat pick 1 has a teardrop shape when viewed in plane. It has a uniformly thin body that widens at the top and tapers down to a rounded point at the bottom. Its two faces are smooth and parallel to each other.

We conceptualize the pick as comprising two functionally distinct, yet conjoined, portions. One portion, the “gripping portion” 2, is designed to be grasped by the fingers, serving as the means by which the plectrum 1 is held during use. The other portion, the “striker” 3, is designed to strike the strings of an instrument to produce the desired musical sounds. Still referring to FIG. 1, a dashed demarcation line A-A is drawn between the two portions of a conventional flat pick 1. This line is perpendicular to the long axis L of the pick and located approximately one-third up along the distance from bottom to top. In actuality, the depth of the striker 3 that interacts with the instrument strings varies widely due to differences in musicians' playing styles, so this demarcation line is somewhat arbitrary. Even an individual player, over the course of a performance, will usually vary how deeply the striker 3 is placed alongside the string prior to engaging it.

### Gripping Area of Conventional Flat Plectrum: Five Gripping Positions

Each of the two sides of a gripping portion 2 serves as a surface that the musician uses to grip the plectrum 1, with the associated edge typically not involved. The gripping portion 2 must be held by at least two fingers. The remaining fingers can be positioned in a variety of ways, reflecting personal preferences. These positions can range from near full extension to near full flexion. The key requirement is that the musician must be able to accurately direct the striker to contact a specific string on the instrument without any of his/her non-gripping fingers touching the same string or otherwise obstructing the picking action.

Musicians use various finger configurations, referred to here as “gripping positions,” to hold the gripping portion 2. FIG. 2A-E illustrate the five positions that we will review. To facilitate this, FIGS. 3 and 4 provide a schematic summary of the anatomical terminology that will be employed henceforth for labeling the parts of human fingers that are critical to these gripping positions, as well as for gripping the invention plectrum in particular, as will be discussed in upcoming presentations.

The most popular gripping positions involve some version of a pinching grip performed by the thumb 15 and the index finger 14. These versions share a common feature, namely that one side of the gripping portion 2 is pressed against by a substantial portion of the palmer surface of the thumb pad, with the thumb 15 typically more or less fully extended. They differ mainly in the specific location where the other side of the gripping portion 2 comes into contact with the index finger 14.

Most commonly, it is just the distal pad of the index finger 14 that is involved in the gripping process, but musicians vary among themselves by preferring to use different portions of that pad, based on personal comfort and playing style. (We note here that for our present purposes, we consider the entire pad region on the distal end of the finger as the “distal pad.” This means we are combining the pad area at the very end, the so-called “tip pad,” with the area just behind it, which in more precise anatomical discussions is considered to be the distal pad on its own.) Some use the full palmer surface of the distal pad, while others prefer using the full radial surface. The latter surface is conceptualized here as lying at a 90-degree angle to the palmer surface when looking at a cross-section of the tip of the index finger. We label these two extremes of gripping positions as the “full palmer position” (FIG. 2A) and the “full radial position” (FIG. 2B). We note in passing that the ulnar side of the index finger pad does not come into play in any of the conventional gripping positions. However, in one gripping position of the invention plectrum 1, to be discussed later on, that side of the index finger 14 does play a prominent role.

Other musicians fall somewhere in the range between the full palmer and the full radial positions, by preferring to place one side of the gripping portion 2 against the index finger 14 distal pad at some contact angle between the two extremes. We label this playing position as the “angle position”, and in most cases the plectrum is placed at an angle of between 30 and 60 degrees (FIG. 2C).

Another fairly popular finger configuration for holding the gripping portion 2 also involves the same two digits as above, including using the palmer surface of the thumb 15 in more or less the same manner. But in this gripping position, the other side of the griping portion is mostly pressed up against the radial side of the intermediate finger pad. We refer to this as the “key position”, borrowing a term used in other fields to describe this finger configuration by which a person typically grips a common door key (FIG. 2D).

The flexion of the thumb 15 remains consistent across the four different gripping positions described thus far, being more or less fully extended, but the index finger 14 exhibits different degrees of flexion across the four positions: it is nearly fully extended in the full palmer position and becomes increasingly flexed as it moves toward the key position, where it is almost fully flexed.

The degree of flexion of the other three fingers varies widely depending on the gripping position being employed and the personal preferences of the musician. The main concern is that the orientation of these digits does not obstruct the musical process. The key position is the one among the four that is the most demanding of a set finger configuration, as all three non-gripping fingers have to be quite fully flexed, or else they will obstruct the musician's ability to strike the targeted instrument string.

A fifth gripping position that we need to identify involves the use of three fingers: thumb 15, index finger 14, and middle finger 13. This position is essentially a variation of the full palmer position, with the palmer surface of the distal pad of the middle finger 13 working in unison with the palmer surface of the distal pad of the index finger 14. These side-by-side surfaces press against one side of the gripping portion 2. We label this three-finger pinching configuration as the “three jaw chuck position”, borrowing a term from other fields to describe this gripping style (FIG. 2E). Both the index finger 14 and the middle finger 13 are mostly fully extended in this position, and the other two fingers are flexed to varying degrees so as to be out of the way.

It is important to note that the gripping position used at any given moment by a musician may vary. This can occur as the musician purposefully shifts the pick 1 to engage with different portions of the index finger 14 or middle finger 13, or the pick 1 may unintentionally move to different areas due to gripping issues (a topic we will consider in detail in upcoming discussions). Therefore, these five labeled gripping positions should be viewed as ideal models created for discussion purposes.

### Three Problems with Prior Art Plectrums Related to Gripping Positions

Having described five gripping positions, we now identify three important problems with prior art plectrums:
(1). The prior art does not seem to include any instances of the gripping portion 2 of a plectrum 1 designed to be held using the combination of the index 14 and middle fingers 13 (recall that the “three jaw chuck” gripping position does use these two digits, but along with the thumb).
(2). In all five gripping positions the gripping portion 2 of the vast majority of prior art plectrums 1 only interacts with a limited portion of the radial side of the index finger 14, specifically with a relatively small area positioned somewhere along the length comprised of the distal and intermediate pads, but seldom over this entire length at the same time, and not at all with the proximal pad (FIG. 4). This is largely due to the small size that characterizes the gripping portion 2 of these plectrums 1. Their sides simply are not long enough to come into contact with that much area on the radial side of the index finger 14. The conventional flat pick, however, is substantially larger overall, and particularly in the length of its sides, than nearly every plectrum found in the prior art. (U.S. Pat. No. 3,735,663, Musician's Pick, is one prior art plectrum that approaches the size of the invention plectrum but otherwise differs greatly in its design).
(3). As a third problem with prior art plectrums, in all five gripping positions none of these plectrums make any contact with the palmar surface of the index finger 14 in the area of either the intermediate pad, the proximal pad, or the interphalangeal crease that lies between them (FIG. 3).

### Hybrid Picking and Fourth Problem With Prior Art Plectrums

Before concluding this discussion on gripping positions, we need to briefly introduce a technique known as hybrid picking. In this technique a musician uses a plectrum to pluck the instrument strings, typically the lower bass strings, while using bare fingers to engage other strings, usually the higher ones, using the two striking means either simultaneously or alternately. The pick 1 is held almost always using one of the thumb-index finger 15, 14 configurations described above, so only the other three fingers are available for fingerpicking. (We should point out that some musicians, while playing, are able to move the pick quickly from the thumb/index finger 15, 14 configuration to another site in the same hand, and thus can have access to all five fingers for fingerpicking. This is a difficult maneuver, however, requiring a high level of skill).

We consider the above situation to be a fourth major problem common to prior art plectrums. As a remedy, in one gripping position of the invention plectrum (later labelled as the rear gripping position), the musician can securely hold the main body between the index finger and the middle finger, and in such a manner that the tips of all five fingers are free for fingerpicking. This allows the musician to easily switch back and forth, on the fly, from using the plectrum to strike any one of the instrument strings to using any of his/her five fingers for the same purpose. This capability greatly facilitates the hybrid picking style, and is a groundbreaking improvement taught by the invention plectrum.

### One Size Fits All: Fifth Problem with Prior Art Plectrums

To conclude this section dealing with the gripping portion 2, we identify a fifth problem of prior art plectrums: for the most part they follow a “one size fits all” model in terms of the size of the plectrum, which directly relates to the size of the gripping portion 2. Worded another way, they do not disclose an intention that their plectrum 1 will be manufactured in various sizes to cater to the differing dimensions of the relevant fingers, or overall hand sizes, of stringed-instrument musicians as a whole.

### Striker of Conventional Flat Plectrum

Moving on from our treatment of the gripping portion 2, we turn our attention to the other portion of a conventional flat pick 1, the striker 3 (FIG. 1). It is the pointed end of the plectrum 1 that comes into contact with the strings of the instrument. It is designed to be resilient yet flexible to various degrees, allowing it to effectively engage with the strings to produce desired sounds. It is triangular in plane view, with two strongly laterally compressed sides which share two “outer” edges. Recall that in our presentation framework here the third edge is the arbitrary, straight demarcation line between the gripping portion 2 and the striker 3, so it is not really a physical edge. The two outer edges are convex, bilaterally symmetrical, and taper gradually to a rounded point.

Both of the flat sides and the two convex edges of the conventional striker are intended to function as the surface areas that come into contact, singly, with one or more instrument strings. Which entity actually does so in a specific playing episode depends upon how the musician decides to direct the striker relative to the string(s). To delve further into the dynamics of this situation we give the following overview of the interaction between the striker and instrument strings.

### Striker and Instrument String Interaction: Clock Positions on the String

We start with a musician directing one of the flat surfaces of a striker so that it comes into contact with a taut string. He does so with sufficient force and at a certain angle of attack that adequate kinetic friction exists at the time of impact between the flat surface of the striker and the outer surface of the string so that the string is then pushed out from its resting state. This string movement occurs to varying degrees depending upon the applied force. To end the maneuver, the musician pulls the striker away from the string, thus releasing it and causing it to vibrate, all of these successional steps usually taking place in a second or less. This vibration is what produces the desired musical note, which is then amplified by other components of the instrument or by a machine, such as an amplifier.

Next, as shown in FIG. 5, we visualize an instrument string in its cross-sectional shape of a circle. The point where the striker comes into contact with the string can be described by reference to an imagined clock face superimposed on the cross-section. The portion of the string furthest away from the body of the instrument would be 12 o'clock, and that portion closest to the body would be 6 o'clock. We posit that the musician is using one of the flat sides of the striker to engage with a string. The direction of the stroke, usually labeled as either a downstroke or an upstroke, and the angle of approach used to direct the striker, determine where it strikes the string. This location most commonly falls within what we label here as one of the “playable clock positions”: the general vicinity between 7 o'clock to 11 o'clock on the side of the string closest to the musician's head, and between 1 o'clock to 5 o'clock on the side of the string farthest from the musician's head.

Striking the string at the range between 5 o'clock and 7 o'clock, while physically possible, requires highly atypical wrist, hand and finger positions, and thus is ergonomically uncomfortable and results in an inefficient playing style. This is especially true as one approaches the 6 o'clock position, from either side of it, whereupon it becomes increasingly difficult to make contact with that portion of the string with one's striker.

Similarly, hitting the string in the approximate range between 11 o'clock to 1 o'clock while using the flat side of the striker is problematical, since adequate contact area does not exist there, with the result that it does not effectively engage and move the string from its resting position. This situation worsens the closer one gets to the 12 o'clock position, from either side of it, such that at a certain point the only way to produce a sound there is to forego the use of the flat surface of the striker, and instead use the edge of the entire plectrum, a technique we discuss now.

### Using Edge of Plectrum at 12 o'clock Position: 6th Problem of Prior Art Plectrums

It is possible to use one of the combined edges of a conventional flat pick, that is, the conjoined edge of the gripping portion 2 and the striker 3, to strike downward at the 12 o'clock position onto one or more instrument strings, essentially at the same time. The small size of a conventional pick dictates that the total edge length usually is less than the distance between four strings, so usually only two to three strings can be struck in this manner. The best method is to thrust downward with substantial force in a hitting action, similar to a hammer striking a nail. Then, to quickly pull the edge away so that the string(s) can vibrate. However, this action is ergonomically awkward, since it requires a major pronation of the wrist and perhaps some shifting of the gripping position on the gripping portion 2 in the fingers. More importantly, however, given the thinness of the edge and the low overall mass of the plectrum, the resultant blow to the string(s) lacks the momentum needed for effective sound. Thus, even if the musician can successfully contort his/her wrist and fingers to perform the striking action, the produced sound tends to be low volume and characterized by poor tonal quality.

This leads us to identifying the sixth major problem with the majority of prior art plectrums, namely that they do not allow for the effective use of the 12 o'clock string position to produce musical sounds. The flat surface of the striker of these plectrums cannot be used at all in this regard, as we've discussed above, while using the combined edge surface is largely ineffectual. Two exceptions do exist to this generalization in the prior art, as follows:
(1). U.S. Pat. No. 7,238,869B1 (Kleckzka), entitled Multi-Function Plectrum, discloses a multi-strikered plectrum, one of the strikers being what could be viewed in our present framework as a robust, highly modified edge that is intended to be employed to strike one string at a time, by coming down upon it from the 12 o'clock position.
(2). U.S. Pat. No. 5,419,228, entitled ‘Musical Instrument Pick with Multiple Playing Surfaces’, by Garrett and Garrett, discloses a plectrum that features a “metal bar extending along the top of a conventionally shaped pick body”. The bar is rounded and used to perform “slide” and “finger tapping” techniques upon the 12 o'clock string position of strings, being configured to strike only one string at a time in the finger tapping use, and seemingly 2 or 3 strings in the slide use.

As somewhat of a related aside, on the subject of striking multiple instrument strings at the same time, we now acknowledge the existence of prior art plectrums that teach the ability to strike two instrument strings at the same time using the flat surface of a striker. This is accomplished by a plectrum configured with two identical strikers, one aligned above the other, with appropriate distance between the two, so that each can pluck a separate string at the same time [see U.S. Pat. No. 9,972,290 Plectrum With Second Striking Member].

### General Attributes of Strikers and Multi-Tipped Plectrums

The prior art teaches that strikers are highly variable in three main attributes, namely shape, thickness, and material composition, as inventors have taught various ways to produce better or new desired sounds. We can briefly review how these three main attributes affect the sound produced from a plucked instrument string. Looking first at shape variability, a more pointy striker allows for more precise string targeting than does a more rounded one, which is advantageous for intricate playing techniques like fast picking or intricate solos. Also, a more pointy one produces a brighter and more articulate tone than does a more rounded one, which tends to produce a warmer and smoother sound.

Turning to thickness variability, a thicker striker tends to make a louder and warmer sound, in comparison to the more subtle, brighter sound of a thinner one, as each has a different effect on the vibration produced in a plucked string. Further, a thicker striker has different playability characteristics, being stiffer and offering more precision and control, thus being more amendable to single note lead playing and intricate picking patterns. In contrast a thinner striker is more flexible, but generally less accurate, making it more amendable to strumming and rhythm playing.

Finally, regarding material composition, the prior art reveals that strikers, as well as the gripping portion 2, since the two nearly always are conjoined and manufactured from the same material, have been made from a wide variety of materials, including natural ones such as bone, antler, tortoise shell, stone, wood and rubber, and a whole slew of man-made ones, including glass, various metals and many plastics such as acrylic, plexiglass, nylon, celluloid, acetal, lexan, Ultex and Delrin. We need not delve into the specifics here, other than to say in general that each material has a unique effect on the playability and the tone produced by a striker.

Only one example was located in the prior art of a plectrum that features a striker manufactured from a different material than the gripping portion 2 (See U.S. Pat. No. US20110179938A1 (Smith), entitled ‘Pick for an Instrument’). The invention plectrum, however, teaches a modular system of playing tips, such that the musician has a choice as to whether or not the material composition of the playing tip matches that of the main body, which is described later on.

Many prior art plectrums have been disclosed that feature two or more strikers. These vary within the plectrum, usually differing in thickness, shape, or material composition, with the overall aim of offering greater on-the-spot flexibility to the musician. The musician can quickly shift from using one striker to another, allowing for different tones or playing techniques to be achieved while using the same plectrum uninterrupted during a performance. For example, U.S. Pat. No. 7,238,869B1 (Kleckzka), entitled Multi-Function Plectrum, discloses a plectrum with three strikers, one of which is an unusually shaped tip used to strike directly down upon a single instrument string, employing a technique known as fast-tapping hammer-ons. (For a sampling of other multi-striker plectrums, see: U.S. Pat. No. 2,481,759A Plectrum with Two Playing Points; U.S. Pat. No. 2,449,890A Pick for Stringed Instruments; U.S. Pat. No. 6,777,602B2 Plectrum for Use with a Stringed Musical Instrument; U.S. Pat. No. 7,462,768 Guitar Pick; U.S. Pat. No. 2017/00842254A1 An Ergonomic Musical Instrument Plectrum; U.S. Pat. No. 10,600,392B2 Ergonomic Plectrum; and U.S. Pat. No. 4,228,719 Plectrum for Stringed Musical Instruments).

Notably, the invention plectrum also falls into this category, since its main body has two ends, each of which has a playing tip, but the invention plectrum teaches that each of the tips is removably attached to the main body, a configuration that is not found in the prior art. We will further explore this topic in an upcoming section.

### Modular System for Strikers: 7th Problem with Prior Art Plectrums

To address what we view as the seventh major problem with prior art plectrums, nearly all of them are designed as a single object. This object is comprised of a gripping area conjoined with one or more strikers. However, no solution is offered for the situation wherein the striker(s) break off or wear down excessively, rendering the plectrum unusable. It is implied that the consumer has no choice but to purchase a new plectrum.

Only one entry in the prior art seems to acknowledge this problem: U.S. Pat. No. 1,184,561 (Napoletano), entitled “Plectrum for Musical Instruments”. It describes a pick holding device “in which the pick is removably held so as to be conveniently replaced when worn or broken”. However, the invention itself does not propose any solution to making a plectrum with a broken or worn-out striker usable again by being able to replace it with a new striker.

### Striker Thickness Demarcation: 8th Problem with Prior Art Plectrums

A majority of conventional flat picks feature an embossed or ink-printed demarcation somewhere on the body of the pick, indicating the thickness of the striker—a critical measurement that directly affects playing characteristics and must be known by the musician. A persistent problem, seemingly unaddressed in the prior art, is that this demarcation text is often excruciatingly small, making it difficult to read quickly and easily. Musicians typically have to hold the pick just inches from their eyes to discern this highly pertinent information. The issue becomes especially problematical during live performances, where lighting may be suboptimal and the need for rapid striker thickness confirmation is crucial.

### Gripping Issues and Static Friction

The presentation so far has identified eight problems found in prior art plectrums that are improved upon by the invention plectrum. Next, we discuss what is undoubtedly the most recurrent issue focused upon by prior art plectrums: the “grip-ability problem.” Quite simply, it can be difficult to maintain a secure grasp on the gripping portion 2 with the fingers while using a plectrum.

This situation can sometimes result in unwanted movement of the plectrum during a playing session, which can negatively affect playing performance. This is one of the reasons why plectrums have been developed that temporarily attach to a musician's finger. This undesirable movement can range from minor slipping of the plectrum from its desired position to the plectrum flying off into space as the musician loses grip completely. Many factors contribute to this grip-ability problem, but at the heart of the issue lie the forces of static and kinetic friction.

Imagine a person who is simply holding a plectrum motionless between their index finger and thumb: static friction is the basic force at play here. It is defined as the force that resists the relative motion between two objects which are in contact, the two objects in this example being broadly defined as the pick and the musician's fingers. More specifically, however, we need to emphasize that actually two static friction forces are involved: one between the thumb and one side of the gripping portion 2, and another between the index finger and the other side of the gripping portion 2. This observation rarely receives explicit attention in the prior art but is critical for much of the upcoming discussions.

Back to our imagined situation, we could phrase what is happening in another way, by stating in general that static friction is presently successfully preventing the pick from slipping around in the person's fingers. The corollary to this statement, then, is that if the pick does slip later on, which is what our overriding concern is in this entire section, we can say that the static friction has failed. So, we need to examine in some detail just what determines static friction, and under what conditions it fails in the context of plectrum holding. In so doing, we will introduce the associated concept of kinetic friction.

### Static Friction Definition: Normal Force and Coefficient of Static Friction

The two main components involved in the computation of the static frictional force between two objects relate to: (a). the physical characteristics of the surface areas of the two objects, and (b). the force which is pressing the two objects together. In the former regard the concept of “coefficient of static friction” comes into play, and in the latter, the concept of “normal force”.

The coefficient of static friction, thereafter, referred to as COSF, is calculated experimentally (by means which we need not go into here) by observing and measuring how two specific surfaces interact when one tries to move against the other while they are in contact. The differing nature of the surface textures of the two materials is paramount in this said interaction. (It's important to point out that this coefficient is a measurement based on the interaction of the two textures and is not a descriptive measurement of the texture of either of them singly.) In the context of being able to hold a plectrum without it slipping, the COSF plays a crucial role, which we will expound upon shortly, but first we need to define the concept of ‘normal force’.

Normal force is defined as the force pressing the two surfaces together. Again, we need not concern ourselves here with how this force is measured. In our case there are two separate normal forces at play-one generated by the thumb pressing against one side of the gripping portion 2, and one generated by the index finger pressing against the other side of the gripping portion 2. Again, these two normal forces play a crucial role in the dynamics of successful plectrum holding, as will be detailed in upcoming discussions.

Now we are in a position to discuss more completely the concept of the “force of static friction”. It is calculated as being less than or equal to the (multiplied) product of the COSF and the normal force. It adjusts to match the normal force applied to an object, up to a maximum value, known as the maximum static friction. If the normal force exceeds this maximum, the object will start to move, and at this transition point we can say various things, such as, the static friction has ended, or it has been overcome, or that it has failed. The main point is that now another type of friction, so-called kinetic friction, has come into play between the two surfaces. We emphasize that the same surfaces are involved in the process, but now they are moving relative to one another and the friction between them is referred to by this other name, kinetic friction. The moment they stop moving relative to one another, but remain in contact, then we say that static friction is at play again. Of course, if they have moved to the extent that they are no longer in contact, then neither frictional force exists between them.

So, returning to our imagined person holding a motionless plectrum, we can now describe the scene by saying that the plectrum is not slipping due to two separate instances of successful static friction. Each is taking place on opposite sides of the gripping portion 2. Each is determined by a particular combination of a normal force (in one case being applied by the thumb, and in the other case being applied by the index finger) and a COSF (each one particular to the interaction of the respective finger involved and the surface of the respective side of the body 110). To examine this in more detail, we need to break down the specifics of the two static friction forces by taking a closer look at the two normal forces and the two coefficients of static friction present.

Two issues emerge when considering the two normal forces here. The first is the amount of normal force exerted by the thumb versus the index finger. The second is the musician's ability to consciously adjust either of these two forces during a performance, or to maintain them as desired over the course of a performance.

For the first issue, we will assume that the thumb and the index finger are applying approximately equal pressure on the sides of the gripping portion 2. However, some evidence in the academic literature might support the supposition that the thumb exerts more normal force than the index finger in certain gripping positions. This could be particularly true as the gripping portion 2 is seated further toward the proximal end of the index finger. This is due to the anatomical advantage of the thumb to more directly and powerfully oppose against the radial side of the index finger in those locations.

To further explain, in the full palmer gripping position, as previously described, the normal forces exerted by the two digits may be similar. However, at the other extreme, in the key position, it is plausible that the normal force is greater on the thumb side of the gripping portion 2 than on the index finger side. In this case, the index finger essentially may be acting as a stationary entity, potentially supported by the middle finger, against which the thumb is doing most of the pressing. If this is the case, when a pick slips in this type of gripping position, it may very well be due to the failure of static friction on the index finger side of the gripping portion 2, rather than on the thumb side. This has implications for improvements to plectrum design, namely creating one that offers the potential for a high static friction force on the index finger side of the gripping portion 2. The invention plectrum does just that, as will be expounded upon in future discussion.

Addressing the second issue, there is no doubt that the total sum of normal forces being applied to the sides of the gripping portion 2 is under the control of the musician. While it's unclear if a person can consciously direct different amounts of normal force exerted by the thumb versus the index finger in this context, a musician is certainly able to coordinate the bio-mechanical pinching movement between the two digits to either increase or decrease the overall pressure exerted on the sides of the gripping portion 2. Tightening the grip increases the normal force component of the static friction, while loosening it decreases that component. This has a direct effect on the amount of static friction present and, consequently, the probability of the pick slipping in the grip, assuming all other factors remain constant.

So, one way that a musician can seek to prevent pick slippage is by using a heightened grip. This technique is problematic, however, because applying too much pressure with the thumb or index finger can lead to short-term discomfort, strain or pain. Even worse, in the long-term serious finger, hand or wrist injuries, such as carpel tunnel, can develop due to an overly aggressive gripping strategy. Therefore, it is important to find a balance that allows for effective control of the plectrum without causing unnecessary tension or discomfort, or long-term injury. A healthier way to increase the normal force components associated with using a plectrum is to design the gripping portion 2 to be capable of offering a high COSF without the need for excessive gripping. So, let us move on to that subject.

Turning now to an examination of the two coefficients of static friction, we are broadly focusing on the texture of four surfaces: the thumb pad, the index finger pad, and the two sides of the gripping portion 2. Regarding the first two, we are dealing with a specialized type of epidermal skin known as “friction ridge skin”. This is present over the palmar surfaces of the hand and fingers, including the radial surface of the index finger which, as described earlier, is involved in several of the plectrum gripping positions. As the name implies, it is characterized by a corrugated texture created by complex patterns of ridges and valleys, most commonly thought of as fingerprints. This texture contributes to a higher COSF in instances when the skin comes into immobile contact with another surface, such as the sides of the gripping portion 2, than would otherwise be the case if the skin did not possess these ridges and valleys.

The friction ridge skin of both the thumb pad and the index finger pad contributes to the two static friction forces under examination. However, for the purposes of this discussion, we assume that there is a negligible difference between this skin on the two digits. We posit that the contribution of each to its respective COSF with one side of the gripping portion 2 is equal. It's important to note, however, that the COSF associated with friction ridge skin can change during the course of a musical performance. For instance, one common situation in which a musician may lose their grip on a gripping portion 2 is when the fingers and hand become sweaty. The presence of perspiration, rain, or any other liquid that somehow gets onto the fingers or hand, negatively impacts the COSF between the digit pad and the side of the gripping portion 2 involved, possibly resulting in the slipping of the plectrum. (See U.S. Pat. No. 5,271,308A (Balog), entitled ‘Soft Attack Guitar Pick’, and U.S. Pat. No. US20150310839A1 (Snyder), entitled ‘Speed Pick, Associated Systems and Methods’, for two prior art examples which identify and address this issue).

Turning to an examination of the textures of the two sides of the gripping portion 2, we can begin by assuming that these sides are made from the same material, as is often the case in the prior art. We just need to highlight that the COSF between the epidermis of a finger pad and the surface of the side of an gripping portion 2 can vary substantially depending on the material composition of the latter. We need not elaborate here, but can point out that plectrum materials such as bone, glass, and stone are much more slippery than plectrum materials such as wood, rubber, and plastic. This is the primary reason why plectrums in the prior art have been taught to be manufactured from more preferred materials, such as Delrin and Ultex.

Moving beyond the specific material of the gripping portion 2, the prior art teaches that another major strategy for increasing the COSF is to add some type of permanent texture during manufacture to one or both sides of the gripping portion 2 to increase surface roughness. This can take many forms, including the addition of wire or sheet metal loops (see U.S. Pat. No. 1,263,740A (Burdwise), entitled ‘Pick for Stringed Instruments’), rubber pads (see U.S. Pat. No. 4,993,302A (Jonathan) entitled, ‘Non Slip Guitar Pick’), the addition of hard felt to the plectrum (see U.S. Pat. No. 5,271,308A (Balog), entitled ‘Soft Attack Guitar Pick’), and the spraying of a textured coating.

Many prior art designs feature the molding of embossed dots or bumps and/or ridges and line patterns, the latter essentially mimicking the friction ridge skin against which it is placed. (See U.S. Pat. No. D607,920S Guitar Pick with Ergonomic Shape; U.S. Pat. No. US20110179938A1 (Smith), entitled ‘Pick for an Instrument’).

U.S. Pat. No. 7,145,066B1 (Moreland), entitled ‘Stringed Instrument Pick Grip’, teaches a semi-permanent textural solution to the pick slippage problem. It describes a “thin rubberlike device” that is adhered to one or both sides of the gripping portion 2, but not necessarily permanently, since it can be removed after initial placement, and re-adhered either elsewhere on the same pick, or on other picks. This is possible because the “device adheres to the pick by the natural tackiness of the device, the ultra light weight of the device, and cohesive frictional forces and/or surface tension.”

In this same category we also can include prior art designs that do not directly change the texture of the sides of the gripping portion 2, but rather describe a plectrum holder or cover, into which a conventional-shaped pick is inserted. The holder itself has texture and overall added three-dimensionality that enhances the grip-ability of the enclosed plectrum.

For example, U.S. Pat. No. 655959A (Cochrane), entitled ‘Mandolin Pick-Holder’, describes a device in which “the thumb and finger rest against the shank and pick and the roughened interposed cylinder provides the necessary frictional contact with the thumb and finger to insure a perfect manipulation of the pick against the strings of the mandolin.” U.S. Pat. No. 9,202,446B2 (Gauthier), entitled ‘Stringed Instrument Plectrum Cover’, teaches a plectrum cover which “comprises a thickened member having an open interior. The plucking end of the pick is exposed while the body of the pick is retained within the thickened member, whereby the member increases the thickness of the pick and improves purchase thereof.” U.S. Pat. No. 1,184,561 (Napoletano), entitled “Plectrum for Musical Instruments”, describes a separate sleeve which is intended to be fitted over a plectrum to aid in gripping: “ . . . the holder produces a covering which has great frictional qualities and which provides for a firm grip upon the pick which is impossible with the smooth shell, celluloid or horn picks how in present use.” U.S. Pat. No. 10,600,392 B2 (Holcomb), entitled ‘Ergonomic Plectrum’, briefly discloses an “ergonomic jacket” that has “a slot sized and shaped to releasably receive the pick tip”. This, too, is just a pick holding device, but with the encasing framework being much more ergonomically designed.

All of these above prior art improvements serve to increase the contact interaction between the sides of the gripping portion 2 (and in some cases, the surfaces of the plectrum holders) and the respective epidermal areas of the musician's digits that are involved. This results in a higher COSF, thus ultimately reducing the likelihood that the plectrum will slip. Thus, they allow the musician to use lower, and healthier, normal forces from the thumb and index finger to grip the plectrum.

### Ergonomic Changes to Gripping Portion: 9th Problem with Prior Art Plectrums

In addition to varied material composition and added textural features, another method taught in the prior art for increasing the static frictional force related to a given plectrum involves making even more pronounced structural modifications to the shape of a conventional flat pick. These modifications allow either the thumb, the index finger, or both, to fit better against the sides of the gripping portion 2. The primary effect of these designs is to increase the surface area that comes into contact with the musician's finger pads. The underlying premise is that the greater the surface area, the higher the potential static friction. These designs can be broadly categorized into: depressions, raised walls/stops, and through-holes.

The depression design most commonly is located in the central area of the griping portion 2, and consists of two similarly-shaped depressions, more or less aligned opposite one another on the two sides of the gripping portion 2. Naturally, the overall thickness of the gripping portion 2, compared to a conventional flat pick, must be increased to the extent required to achieve the desired depth of the depressions. In any case, the thumb pad rests in one depression, the index finger pad rests in the other, and a thin wall of material exists between them. The walls of the depressions add to the total surface area of the gripping portion 2 that comes into contact with the finger pads. In some instances, these walls can have added textural features, or grooves or cut-outs in them, or can even function as physical stops for the relevant digits (see U.S. Pat. No. 2015/0262562A1 Guitar Pick; U.S. Pat. No. US20150310839A1 (Synder), entitled ‘Speed Pick, Associated Systems and Methods’.) All of these modifications help to increase the static frictional forces.

The through-hole design takes the process one step further by removing the thin wall of material at the center of the two depressions. This allows a small portion of each of the respective finger pads to press through the resulting hole and touch one another. The skin-to-skin contact naturally has a high COSF, so this modification also can lead to a higher static frictional force, and thus, further decrease the likelihood of plectrum slippage. For example, U.S. Pat. No. 10,600,392 B2 (Holcomb), entitled ‘Ergonomic Plectrum’, teaches one embodiment that possesses “a opening in its center portion” that allows improved feel, grasping and rotation of the plectrum.

A few prior art plectrums take the ergonomic design further, by having each side of the plectrum designed to fit a specific digit, either the thumb or the index finger, respectively. U.S. Pat. No. 10,600,392 B2 (Holcomb 2020), entitled ‘Ergonomic Plectrum’, teaches a plectrum with one or more strikers, and centrally located gripping portion 2. Many different embodiments revealed there feature one or both sides of the gripping portion 2 being ergonomically contoured, using “projections” and “recesses”, with at least one embodiment having a side specifically shaped to fit the thumb and another side being shaped to fit the index finger.

U.S. Pat. No. 2015/0262562A1 (Goble), entitled ‘Guitar Pick’, discloses a plectrum that is designed to permit a player to “hold his/her wrist at a more natural angle when playing”, and at least in one of its embodiments features an “arcuate wall” that rises from the distal end of one side of the gripping portion 2, and in combination with the body of the pick, forms a “cradle for the thumb”. Similarly, an “arcuate ridge” is present on the other side the gripping portion 2 “to form a stop or lower cradle for the player's index finger.” This plectrum clearly designates one side of the gripping portion 2 for the thumb, and the other side for the index finger, with no opportunity to use it any other way.

All of these prior art modifications to the griping portion 2 based on ergonomics seek to increase the relevant static frictional forces, making it more difficult for the pick to slip. Yet, to identify the ninth problem with prior art plectrums, these plectrums feature a griping portion 1 which is relatively small, so even though the gripping portion 2 surfaces are taught to be ergonomically adapted to increase static friction, the overall amount of contact surface is still relatively small. This is especially true in comparison to the invention plectrum.

### Causes of Static Friction Failure

The discussions above provide a framework for analyzing the various ways in which static friction can fail in a plectrum holding situation. We have already noted one instance in which this occurs: when either of the musician's two finger pads becomes wet due to perspiration or contact with another fluid. This reduces the COSF between the pad and the side of the gripping portion 2, causing the pick to slip from the musician's grip.

Another instance in which static friction can fail is when the musician inadvertently decreases the amount of normal force applied by either the thumb or index finger. This phenomenon can also occur during a performance due to fatigue, or due to stresses or injuries that lead to pain in the fingers, hand, or wrist. The end result is the same: the musician may not be able to apply the necessary normal force to one or both sides of the gripping portion 2, resulting in pick slippage.

However, the primary situation in which pick slippage occurs is when the musician actually is striking the instrument strings. We will now examine this situation in detail. While the concept of static friction is crucial for understanding the principles behind successfully holding a motionless plectrum, the concepts of impact force and kinetic friction force become important when we consider this major reason for pick slippage.

We start when the musician directs the striker towards a targeted instrument string and hits it. The force of impact depends on the mass of the pick and its speed at the moment of impact (this is a manifestation of Newton's second law of motion), both of which are under the conscious control of the musician. That is, the musician has chosen the given pick, with its inherent size and mass, and he/she purposefully applies a given amount of energy to the pick when striking the string. If the plectrum does not immediately slip in the player's fingers, this implies that the force of impact was not greater than the weakest of the two static friction forces prevailing on the two sides of the griping portion 2.

Immediately upon impact, the force of kinetic friction comes into play. As we stated earlier, kinetic friction applies to objects that are moving relative to one another. In our case, it resists the motion of the striker as it slides across the string. Like static friction, the amount of kinetic friction depends on the material composition and textures of the contact surfaces involved—in this case, the striker and the instrument string-as well as the force being applied by the striker. This latter force is determined by the speed and angle at which the musician is moving the pick.

If the plectrum slips from the player's fingers after the striker has made contact with the instrument string, and now is interacting with it, this implies that the static friction between one or both of the finger pads and its respective side of the gripping portion 2 has failed. In other words, the kinetic friction force at the striker-instrument string interface has overcome the static friction at the plectrum, causing the plectrum to shift in position or even slip out of the musician's hand.

To sum up the discussions so far, successfully using a plectrum requires that the musician consciously, skillfully, and delicately handle the various forces involved, namely, static and kinetic friction and impact force, to ensure that the plectrum does not slip or fly off into space during use. Of course, the other major component of this successful plectrum use hinges upon the characteristics of the plectrum that the musician has chosen to use.

The invention plectrum is designed with the grip-ability problem fully in mind. As described previously, it teaches a much larger surface contact area, much of it ergonomically designed, between the main body and the musician's digits, which translates into a higher static friction force between the plectrum and the user's fingers than that found in other prior art plectrums. This, in turn, greatly helps to prevent the kinetic friction force at the striker-instrument string interface from causing the musician to lose control of the plectrum. The probability of this plectrum slipping within, or flying out of, the musician's grip is very low.

### BRIEF SUMMARY OF THE INVENTION

Aspects of the disclosure are directed to embodiments of a gripping or a holding device including a body extending from a first body end to a second body end. In some embodiments, the body includes a first interface at the first body end, a top edge and an opposing bottom edge. In some embodiments, a first body side is delimited by the first interface, the second end, the top edge, and the bottom edge and includes a first surface portion. In some embodiments, a second body side opposes the first body side and is delimited by the first interface, the second end, the top edge and the bottom edge and includes a second surface portion. In some embodiments, a depression is defined at each of the first and second surface portions. In some embodiments, a finger grip extends between the first body side and the second body side and is positioned towards the bottom edge. In some embodiments, the first interface is configured to removably couple to a first accessory. In some embodiments, the depression and finger grip are configured to facilitate gripping of the body by a user's hand to securely operate the first accessory.

In some embodiments of the holding device, the first interface defines a cavity configured to accept a portion of the first accessory. In some embodiments of the holding device, the second end defines a second interface that comprises a cavity configured to accept a portion of the second accessory. In some embodiments of the holding device, at least one of the first accessory and the second accessory is a playing tip configured to play individual strings on a musical instrument. In some embodiments of the holding device, the top edge of the body further defines a third interface that is configured to removably couple to a third accessory. In some embodiments, the top edge of the body further defines a third interface configured to removably couple to a third accessory. In some embodiments, the top edge defines a groove configured to at least partially accept a tool or a user's fingernail to assist in removal of the third accessory from the third interface. In some embodiments of the holding device, the third accessory comprises a sound rail that is configured to play the top sides of one or more strings of a musical instrument at the same time. In some embodiments, the holding device further comprises a plurality of raised surface features positioned in at least one of: (i) the depression on the first side surface; or the depression on the second side surface, wherein the plurality of raise surface features are configured to engage one or more fingers of a user to increase friction between the one or more fingers and the body. In some embodiments of the holding device, at least one of the first accessory and the second accessory is a holder comprising a retainer configured to at least partially retain a portion of a tool. In some embodiments of the holding device, the top edge defines a groove positioned between the first and second ends of the body.

Aspects of the following disclosure are further directed to embodiments of a holding assembly comprising a body extending from a first body end to a second body end, a first holder, and a second holder. In some embodiments, the body comprises a first interface at the first body end, a second interface at the second body end, and a top edge comprising a groove extending along a portion of the top edge. In some embodiments, the body includes a first body side bounded by the first interface, the second interface, and the top edge. In some embodiments, the body includes a second body side opposing the first body side and bounded by the first interface, the second interface, and the top edge. In some embodiments, the body defines a bore extending between the first body side and the second body side and a depression at least partially surrounding the bore. In some embodiments, the body includes a finger grip extending between the first body side and the second body side, wherein the finger grip is positioned away from the top edge. In some embodiments, the first holder is configured to be removably coupled to the first interface, wherein the first holder comprises a first retainer that is configured to removably engage a first portion of a tool. In some embodiments, the second holder is configured to be removably coupled to the second interface, wherein the second holder comprises a second retainer that is configured to engage a second portion of the tool. In some embodiments, the depression and finger grip are configured to facilitate gripping of the body by a user's hand to securely operate the tool.

In some embodiments, the holding assembly further comprises a securing member configured to be positioned in the groove of the top edge. In some embodiments of the holding assembly the securing member comprises an outer wall defining a central bore and comprising a varying thickness. In some embodiments, the securing member comprises an eccentric cross-section. In some embodiments of the holding assembly, the securing member is configured to retain a third portion of the tool within the central bore. In some embodiments of the holding assembly, the securing member is configured to wedge the first portion of the tool against the first retainer and the second portion of the tool against the second retainer. In some embodiments of the holding assembly, the first interface defines a cavity configured to accept a portion of the first holder. In some embodiments of the holding assembly, the second interface comprises a cavity configured to accept a portion of the second holder. In some embodiments of the holding assembly, the tool comprises a writing utensil.

Aspects of the disclosure are further directed to embodiments of a method for securing a tool in a holding device. In some embodiments, the method includes providing a body extending from a first body end to a second body end and comprising a first interface at the first body end, a second interface at the second body end, and a top edge comprising a groove extending along a portion of the top edge. In some embodiments, the body includes a first body side bounded by the first interface, the second interface, and the top edge. In some embodiments, the body includes a second body side opposing the first body side and bounded by the first interface, the second interface, and the top edge. In some embodiments, the body defines a bore extending between the first body side and the second body side, and a depression at least partially surrounding the bore. In some embodiments, the body includes a finger grip extending between the first body side and the second body side, wherein the finger grip is positioned away from the top edge. In some embodiments, a first holder is provided and is configured to be removably coupled to the first interface, wherein the first holder comprises a first retainer that is configured to removably engage a first portion of a tool. In some embodiments, a second holder is provided and is configured to be removably coupled to the second interface, wherein the second holder comprises a second retainer that is configured to engage a second portion of the tool. In some embodiments, the method includes inserting one end of the tool through first and second retainer and placing a securing member around a third portion of the tool such that the securing member is positioned in the groove of the top edge between the first and second holders. In some embodiments, the method includes rotating the securing member relative to the body, wherein said rotation in the first direction wedges the first portion of the tool against the first retainer and wedges the second portion of the tool against the second retainer and gripping the body using the depression and finger grip to securely operate the tool.

In some embodiments, the method further includes structuring the securing member to comprise an outer wall defining a central bore and comprising a varying thickness. In some embodiments, the method further includes structuring the securing member to comprise an eccentric cross-section. In some embodiments, the method further includes structuring the first interface to define a cavity that is configured to accept a portion of the first holder. In some embodiments, the method further includes structuring the second interface to comprise a cavity that is configured to accept a portion of the second holder. In some embodiments, the method further includes loosening the tool by rotating the securing member in a second direction relative to the body, wherein the second direction is different from the first direction

In some embodiments, the body features a long, robust top edge, significantly longer than the width of the total edge of any prior art plectrum, and specifically longer than the “metal bar” described in the prior art. Attached to this edge is a “sound rail,” which will be detailed in a later section. This sound rail can be employed very effectively, especially given the large overall mass of the invention plectrum, to strike instrument strings in the 12 o'clock position with much more force than in the prior art cases, resulting in louder and more tonal sounds.

In some embodiments, the length of the top edge of the body, with the exception of the smaller body sizes, surpasses the distance across the fretboard of a typical six-string guitar from the lowest to the highest strings. This allows one to engage up to all six strings more or less simultaneously, which is a marked improvement over the prior art cases cited above, where at most, only three strings can be struck.

In some embodiments, the body does not have to be shifted in the user's fingers to bring the top edge of the body, with its attached sound rail, into position above the string assembly. The prior art plectrums have to be completely released from one position grip, flipped approximately 180 degrees, and then re-gripped onto some other portion of the plectrum, a process that is awkward, time-consuming, and risks losing grip on the plectrum. In contrast, when using the invention plectrum, the musician does not have to release the grip or change it in any manner to go from using either one or the other of the two gripping positions (when using one or the other of the two playing tips) to using the top edge as a striking surface. They only have to either pronate or flex their wrist the necessary amount to bring the top edge into striking position above the string assembly, a process that is easy and rapid to perform. This translates into a much quicker and smoother transition, allowing for a more fluid, better playing style.

In some embodiments, the inventive gripper/holder/plectrum introduces a modular system on the two ends of the body. This system is designed for the insertion and removal of playing tips, allowing for the replacement of broken or worn-out tips, or enabling the musician to switch between different styles or types of tips as desired. To this end, the invention plectrum aims to provide a variety of playing tips, varying in size, shape, and material composition, to accommodate different playing styles and personal preferences for particular sounds. More details about this modular system will be presented in a later section.

In some embodiments, the playing tips of the holding device incorporate two key improvements: a. The demarcation text is noticeably larger, and b. An alphabetical system is used on the body of the playing tip to indicate thickness, replacing the conventional numerical system. In this approach, tip thickness increases progressively as one moves further down the alphabet. A chart informs the user of the specific thickness associated with each letter. For example, a Size C playing tip corresponds to 0.46 mm, Size E to 0.71 mm, and Size R to 3 mm.

The advantage of the alphabetical system over the numerical one—particularly when embossing or labeling the limited surface area of a striker/playing tip—is that only a single character is required, whereas the numerical system may require up to three. Take the thickness of 1.2 mm, for instance: the alphabetical system uses just the letter J, while the numerical system requires three characters, which occupy more space and necessitate smaller, harder-to-read text.

In some embodiments the body of the holding device may include raised surface, in the form of branding lettering and patterns of raised dots, labeled here as Pad-Pads, in certain critical areas of the body for increased friction between the fingers of the user and the body of the holding device.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description.

FIG. 1 illustrated a plan view of an embodiment of a prior art flat pick.

FIG. 2A illustrates an embodiment of a full palmar griping position.

FIG. 2B illustrates an embodiment of a full radial gripping position.

FIG. 2C illustrates an embodiment of an angle gripping position.

FIG. 2D illustrates an embodiment of a three jaw chuck gripping position.

FIG. 2E illustrates an embodiment of a key gripping position.

FIG. 3 illustrates a palm view of a human hand.

FIG. 4 illustrates an embodiment of the hand from FIG. 3 showing radial surfaces of the index finger and ulnar surface of the thumb pad.

FIG. 5 illustrates a cross-sectional view of an instrument string represented as a clock face.

FIG. 6A illustrates an exploded view of an embodiment of a holding device configured as a plectrum, according to aspects of the disclosure.

FIG. 6B illustrates a perspective view of an embodiment of a playing tip, according to aspects of the disclosure.

FIG. 6C illustrates side views of various embodiments of decorative accessories that may be used with embodiments of the body of the holding device.

FIG. 7A illustrates a top view of an embodiment of a body of the holding device, according to aspects of the disclosure.

FIG. 7B illustrates a bottom view of the embodiment of the body of the holding device of FIG. 7A, according to aspects of the disclosure.

FIG. 7C illustrates a front view of the embodiment of the body of the holding device of FIGS. 7A and 7B, according to aspects of the disclosure.

FIG. 7D illustrates a rear view of the embodiment of the body of the holding device of FIG. 7A-C, according to aspects of the disclosure.

FIG. 8A illustrates a side view of an embodiment of a body of a holding device, according to aspects of the disclosure.

FIG. 8B illustrates a perspective side view of the embodiment of the body of the holding device of FIG. 8A, according to aspects of the disclosure.

FIG. 8C illustrates a perspective top view of the embodiment of the body of the holding device of FIGS. 8A and 8B, according to aspects of the disclosure.

FIG. 8D illustrates a perspective side view of the embodiment of the body of the holding device of FIG. 8A-C, according to aspects of the disclosure.

FIG. 8E illustrates a perspective bottom view of the embodiment of the body of the holding device of FIG. 8A-D, according to aspects of the disclosure.

FIG. 8F illustrates a perspective bottom view of the embodiment of the body of the holding device of FIG. 8A-E, according to aspects of the disclosure.

FIG. 9A illustrates a side view of an embodiment of a body of a holding device, according to aspects of the disclosure.

FIG. 9B illustrates a perspective side view of the embodiment of the body of the holding device of FIG. 9A, according to aspects of the disclosure.

FIG. 9C illustrates a perspective top view of the embodiment of the body of the holding device of FIGS. 9A and 9B, according to aspects of the disclosure.

FIG. 9D illustrates a perspective side view of the embodiment of the body of the holding device of FIG. 9A-C, according to aspects of the disclosure.

FIG. 9E illustrates a perspective bottom view of the embodiment of the body of the holding device of FIG. 9A-D, according to aspects of the disclosure.

FIG. 9F illustrates a perspective bottom view of the embodiment of the body of the holding device of FIG. 9A-E, according to aspects of the disclosure.

FIG. 10A illustrates a sectional view from a top edge to a bottom edge of a body of a holding device showing a socket, according to aspects of the disclosure.

FIG. 10B illustrates a perspective side view of the embodiment of FIG. 10A, according to aspects of the disclosure.

FIG. 10C illustrates a perspective side view of the embodiment of FIG. 10A, according to aspects of the disclosure.

FIG. 10D illustrates a longitudinal section of an embodiment of a body of a holding device.

FIG. 11A illustrates a side view of an embodiment of a holding device configured as a plectrum, according to aspects of the disclosure.

FIG. 11B illustrates another side view of the embodiment of FIG. 11A, according to aspects of the disclosure.

FIG. 11C illustrates a perspective bottom view of the embodiment of a holding device configured as a plectrum of FIGS. 11A and 11B, according to aspects of the disclosure.

FIG. 11D illustrates a perspective bottom view of the embodiment of a holding device configured as a plectrum of FIGS. 11A-11C, according to aspects of the disclosure.

FIG. 11E illustrates a perspective rear view of the embodiment of a holding device configured as a plectrum of FIGS. 11A-11D, according to aspects of the disclosure.

FIG. 11F illustrates a perspective side view of the embodiment of a holding device configured as a plectrum of FIGS. 11A-11D, according to aspects of the disclosure.

FIG. 12A illustrates a side view of an embodiment of a sound rail accessory, according to aspects of the disclosure.

FIG. 12B illustrates a perspective cross-sectional view of the embodiment of the sound rail accessory if FIG. 12A, according to aspects of the disclosure.

FIG. 12C illustrates a bottom view of the embodiment of the sound rail accessory of FIGS. 12A and 12B, according to aspects of the disclosure.

FIG. 12D illustrates a top view of the embodiment of the sound rail accessory of FIGS. 12A-12C, according to aspects of the disclosure.

FIG. 12E illustrates a top perspective view of installing the embodiment of the sound rail accessory of FIGS. 12A-12D on an embodiment of a body of a holding device, according to aspects of the disclosure.

FIG. 13A illustrates a close-up, side view of a front end of the left side of an embodiment of a body of a holding device, according to aspects of the disclosure.

FIG. 13B illustrates a close-up, side view of a rear end of the left side of an embodiment of a body of a holding device, according to aspects of the disclosure.

FIG. 13C illustrates a perspective cross-sectional view through an embodiment of a body of a holding device with an embodiment of a sound rail, according to aspects of the disclosure.

FIG. 14A illustrates a perspective side view of an embodiment of a body of a holding device showing raised surface features, according to aspects of the disclosure.

FIG. 14B illustrates a perspective side view of the embodiment of the body of the holding device of FIG. 14A showing raised surface features, according to aspects of the disclosure.

FIG. 14C illustrates a close-up a perspective side view of an embodiment of the raised surface features of FIGS. 14A and 14B, according to aspects of the disclosure.

FIG. 15A illustrates a perspective front view of an embodiment of a front gripping position according to aspects of the disclosure.

FIG. 15B illustrates a front view of the embodiment of the front gripping position of FIG. 15A, according to aspects of the disclosure.

FIG. 15C illustrates a left side view of the embodiment of the front gripping position of FIGS. 15A and 15B, according to aspects of the disclosure

FIG. 15D illustrates a playing view of the embodiment of the front gripping position of FIG. 15A-C, according to aspects of the disclosure.

FIG. 16A illustrates a front view of an embodiment of a rear gripping position, according to aspects of the disclosure.

FIG. 16B illustrates a perspective front view of the embodiment of the rear gripping position of FIG. 16A, according to aspects of the disclosure.

FIG. 16C illustrates a side view of the embodiment of the rear gripping position of FIGS. 16A and 16B, according to aspects of the disclosure.

FIG. 16D illustrates a top view of the embodiment of the rear gripping position of FIG. 16A-C, according to aspects of the disclosure.

FIG. 16E illustrates a bottom view of the embodiment of the rear gripping position of FIG. 16A-D, according to aspects of the disclosure.

FIG. 16F illustrates a playing view of the embodiment of the rear gripping position of FIG. 16A-E, according to aspects of the disclosure.

FIG. 17A illustrates a perspective side view of an embodiment of the holding device configured as a plectrum set at a 90° angle relative to strings of a musical instrument, according to aspects of the disclosure.

FIG. 17B illustrates a rear view of the embodiment of FIG. 17A, according to aspects of the disclosure.

FIG. 17C illustrates the embodiment of FIG. 17A showing a cross-sectional view of the strings of the musical instrument, according to aspects of the disclosure.

FIG. 18A illustrates a perspective side view of an embodiment of the holding device configured as a plectrum set at a 45° angle relative to strings of a musical instrument, according to aspects of the disclosure.

FIG. 18B illustrates a rear view of the embodiment of FIG. 18A, according to aspects of the disclosure.

FIG. 18C illustrates the embodiment of FIG. 18A showing a cross-sectional view of the strings of the musical instrument, according to aspects of the disclosure.

FIG. 19A illustrates an exploded view of another embodiment of a holding device, according to aspects of the disclosure.

FIG. 19B illustrates a side view of an embodiment of first and second holder accessories of the embodiment of the holding device of FIG. 19A, according to aspects of the disclosure.

FIG. 19C illustrates front and rear views of the embodiment of the first holder accessory of FIG. 19B, according to aspects of the disclosure.

FIG. 19D illustrates a side view of an embodiment of the holding device of FIG. 19A holding a paint brush, according to aspects of the disclosure.

FIG. 19E illustrates a perspective side view of an embodiment of the holding device of FIG. 19A holding a pencil, according to aspects of the disclosure.

FIG. 20 A illustrates a side view of another embodiment of a holding device, according to aspects of the disclosure.

FIG. 20B illustrates a perspective side view of the embodiment of FIG. 20A, according to aspects of the disclosure.

FIG. 20C illustrates a side view of another embodiment of a holding device, according to aspects of the disclosure.

FIG. 20D illustrates a perspective side view of the embodiment of FIG. 20C, according to aspects of the disclosure.

### DESCRIPTION OF THE INVENTION

The following discussion relates to various embodiments of a modular customizable ergonomic holding device. It will be understood that the herein described versions are examples that embody certain inventive concepts as detailed herein. To that end, other variations and modifications will be readily apparent to those of sufficient skill. In addition, certain terms are used throughout this discussion in order to provide a suitable frame of reference with regard to the accompanying drawings. These terms such as “upper”, “lower”, “forward”, “rearward”, “interior”, “exterior”, “front”, “back”, “top”, “bottom”, “inner”, “outer”, “first”, “second”, and the like are not intended to limit these concepts, except where so specifically indicated. The terms “about” or “approximately” as used herein may refer to a range of 80%-125% of the claimed or disclosed value. With regard to the drawings, their purpose is to depict salient features of the modular customizable ergonomic holding device and are not specifically provided to scale.

The following description is intended to provide illustrative embodiments of the inventive gripping device or plectrum and is not intended to limit the scope of precise form that the device may take. Variations and modifications may be made without departing from the purview and scope of the invention. The embodiments were chosen and described in order to best explain the principles of the invention and its practical application, thereby enabling others skilled in the art to understand the invention for various embodiments and with various modifications as are suited to the particular use contemplated. The illustrated embodiments pertain to a plectrum intended to be held in the right hand of a musician.

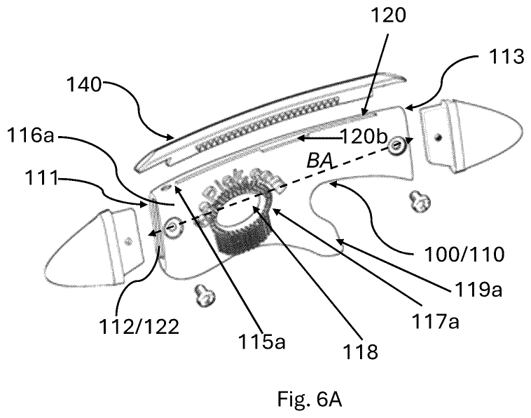

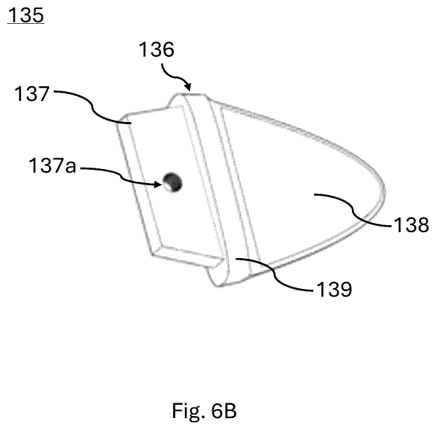

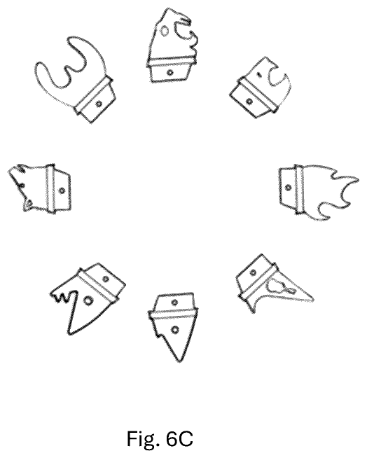

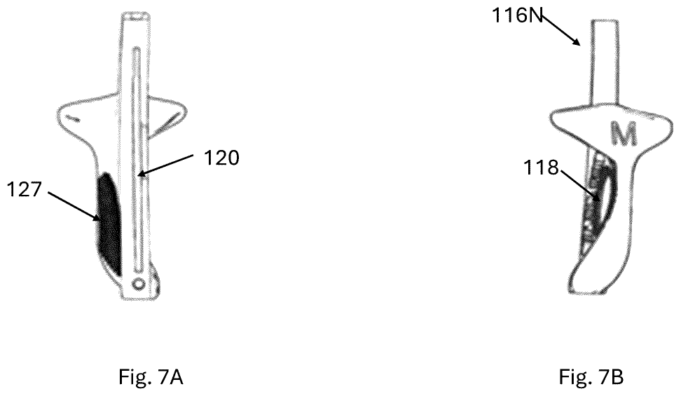

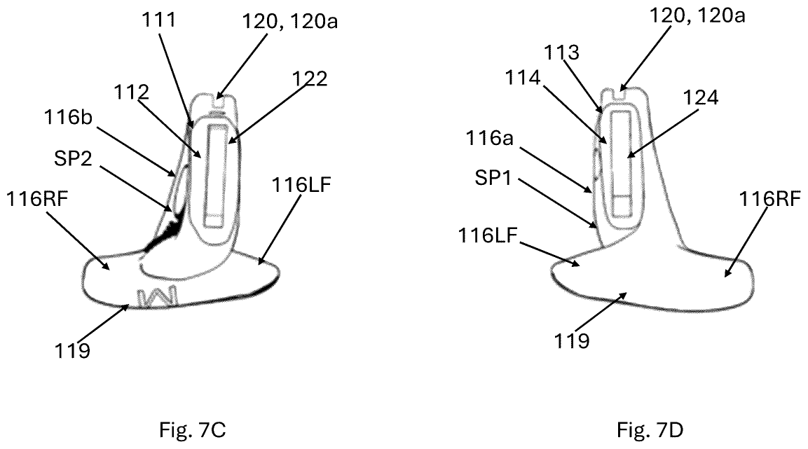

Referring to FIGS. 6A, 7A-11F, in some embodiments, the holding device 100 includes a main body or body 110 extending along a body axis BA between a first body end 111 and a second body end 113. In some embodiments, the body 110 defines a first interface 112 at the first body end 111 and a second interface 114 at the second body end 113. While many of the embodiments discussed include a first interface 112 at the first body end 111 and a second interface 114 at the second body end 113, it is envisioned that other embodiments only include an interface at one of the first 111 or second 113 ends. In some embodiments, a first accessory 132 is removably coupled to the first interface 112 and a second accessory 134 is removably coupled to the second interface 114. In some embodiments, the first and second accessories 132, 134 are identical to each other. In some embodiments, the first and second accessories 132, 134 are different from each other. In some embodiments, the first and second accessories 132, 134 are playing tips that may be used to interact with the strings of a musical instrument to produce an audible sound. In some embodiments, the body 110 includes a sound rail 140 positioned along the body at a point between the first and second body ends 111, 113. In some embodiments, the sound rail 140 may be removably coupled to the body 110 at a third interface 120. In some embodiments, the first and second accessories 132,134 and/or the sound rail 140 may be coupled to the body 110 through a snap-fit or friction fit connection via the corresponding interface. In some embodiments, the first and second accessories 132,134 and/or the sound rail 140 may be coupled to the body 110 using one or more mechanical fasteners. In this manner the first and second accessories 132,134 and/or the sound rail 140 are interchangeable components such that the device 100 may be customized to suit a particular user.

Still referring to FIGS. 6A, 7A-11F, in some embodiments, the body 110 exhibits a very organic shape, with many curves and undulations that give it a unique and distinctive aesthetic. In some embodiments, the body 110 comprises an asymmetric structure and ergonomic shape. As previously discussed, the body 110 is elongated and extends along the body axis BA between the first and second ends 111, 113. In some embodiments, the body 110 has a first side surface 116a defining a first surface portion SP1 and a second side surface 116b defining a second surface portion SP2. In some embodiments, the first and second surface portions SP1, SP2 are laterally compressed. In some embodiments, the first and second side surfaces 116a, 116b share a common top edge 115a and bottom edge 115b. In other words, the thickness of the body 110 may vary between the first end 111 and the second end 113 and may be thinnest towards the middle of the body 110.

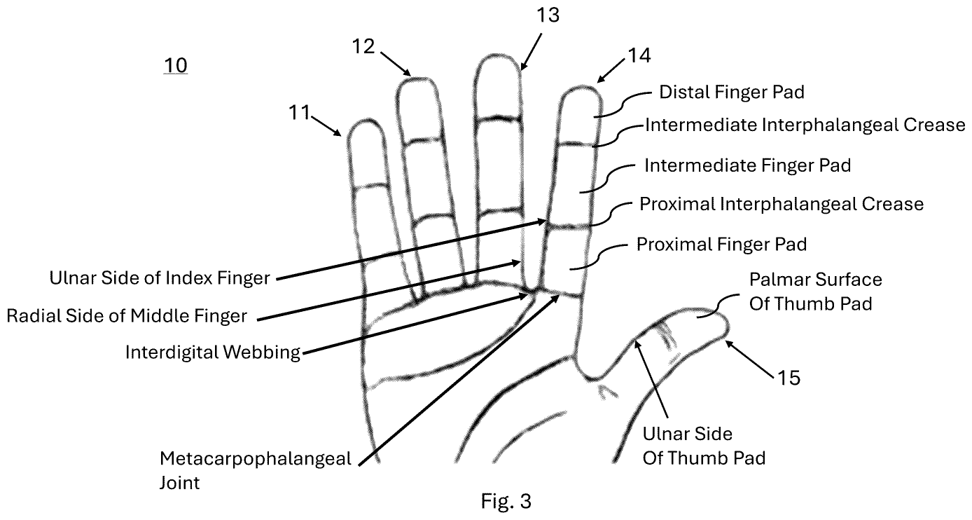

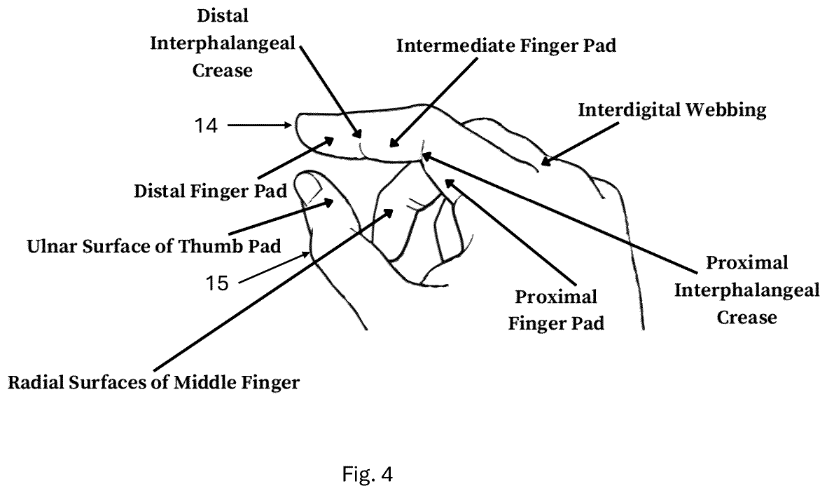

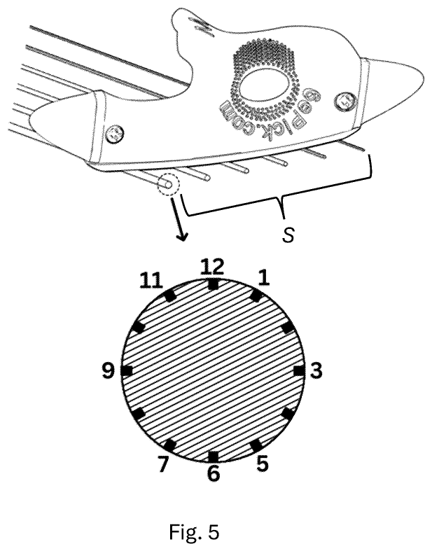

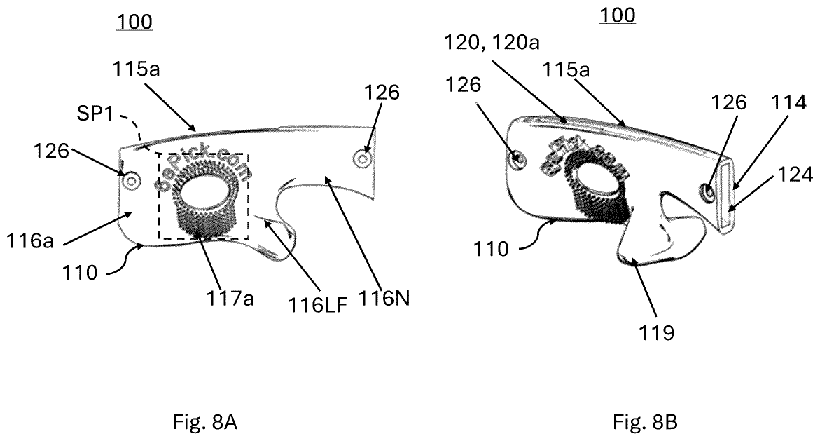

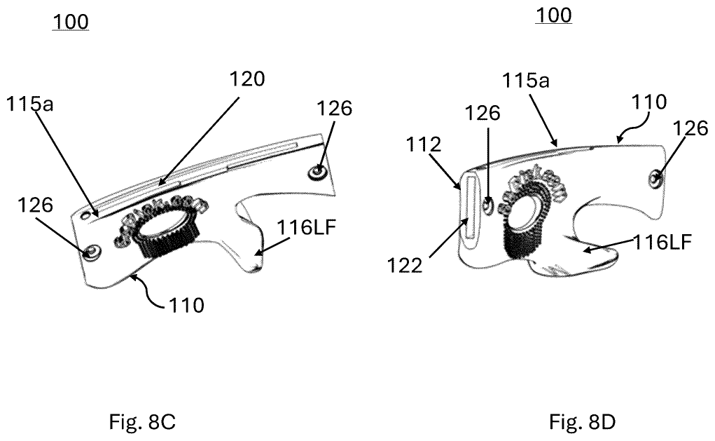

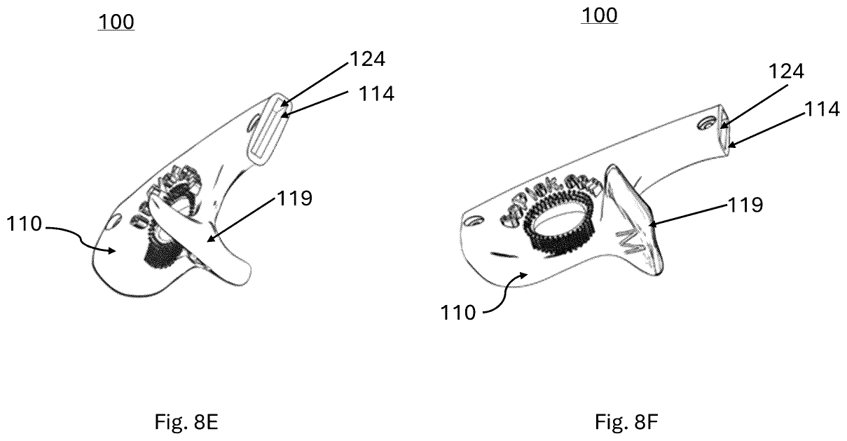

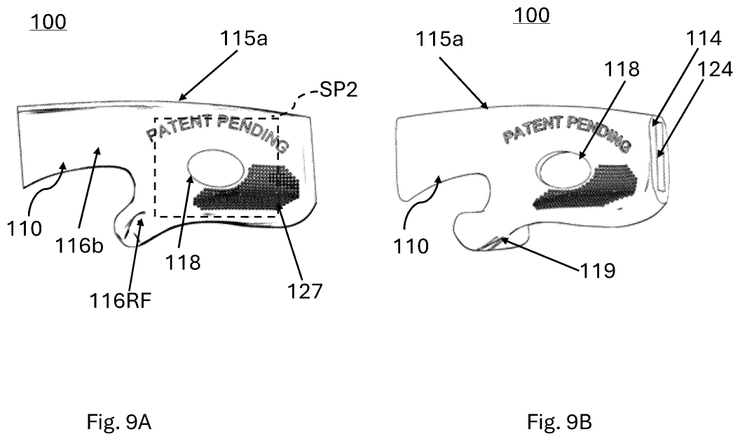

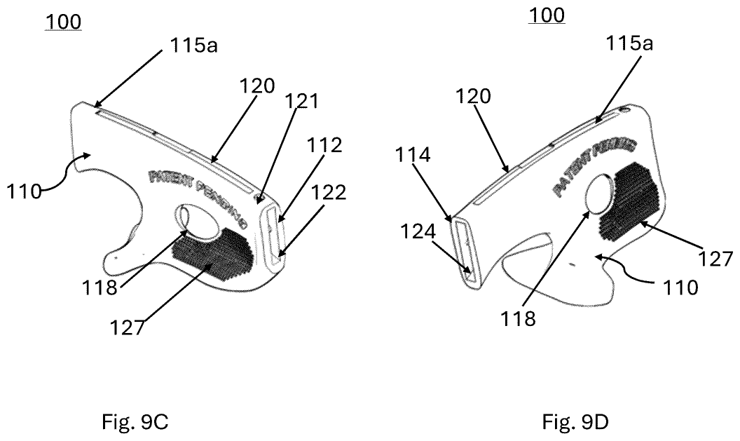

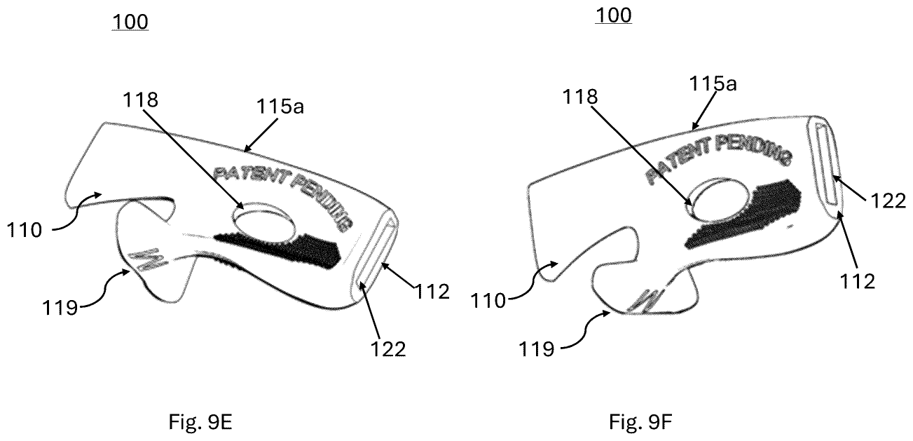

Referring to FIGS. 6A, 8A-11F, 14A, and 14B, the two opposing side surfaces 116a, 116b exhibit a curved and/or wavy pattern. Both sides feature a complex curved surface, with one major concave depression 117 conjoined with a narrower neck section. In some embodiments, the first and second surface portions SP1, SP2 (FIGS. 8A and 9A) of body 110 defines a through-hole 118 located in the two concave depressions 117 a, 117 b. In effect, each side surface 116 a, 116 b of the body 110 is ergonomically configured to receive the surfaces of the finger pads that come into contact with it. In some embodiments, each side surface 116a, 116b includes a convex protuberance 119a, 119b that extends perpendicularly from the bottom center area of the surface. In some embodiments, the two protuberances conjoin at their shared medial edges to form an overall shape suggestive of the ventral fins of a fish. This shape is ergonomically configured to function as two conjoined “finger grips,” i.e., the right finger grip 116RF and the left finger grip 116LF which, in combination with the other above-described features of the two side surfaces 116a, 116b, ensure that the body 110 may be held snugly and securely by the user so that it comfortably contacts with the fingers 11-15 (FIG. 3) of the user. Given that both ends 111, 113 of the body 110 are equally functional, that is, they both may include interfaces configured to removably receive an accessory, the overall device 100 lacks a front end or a rear end in the traditional sense. In some embodiments, the body 110 further comprises mounting elements 126 configured to aid in removable coupling first and second accessories 132, 134 to the body 110. As will be detailed in upcoming presentations, the body 110 features an overall main body size and length that dwarfs nearly every prior art plectrum, allowing the body 110 to extend over a much larger area of the index finger 14 (and middle finger 13, in one gripping position). This is partly attributable to the long neck portion 116N of the body 110. This development creates much more contact between the body 110 and the user's skin. Additionally, large ergonomic depressions exist on both sides of the body 110, conjoined with the long neck 116N, and a through-hole 118 connects the two depressions 117a, 117b. Each depression is shaped to closely match the outside contour of the respective digit pad(s) that engage with it, and each depression also has raised branding lettering 128 and patterns of raised dots 127, 129 (Pad-Pads), resulting in an even greater amount of contact surface. In some embodiments, the Pad-Pads 127, 128 may be formed on contoured surfaces of the body 110 to further promote easy and comfortable gripping of the body 110 by the use. Finally, the presence of the two sizable finger grips 116RF, 116LF, which have no counterpart in the prior art, adds a tremendous amount of additional surface contact area, primarily in portions of the user's finger pads that other plectrums do not touch at all. All of this contributes to a greatly improved plectrum device with regard to the amount of potential contact surface between the main body 110 and the pad areas of the user's relevant digits.

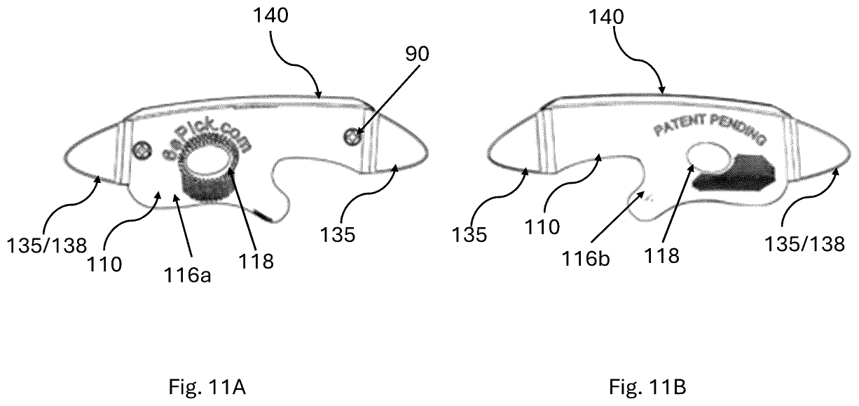

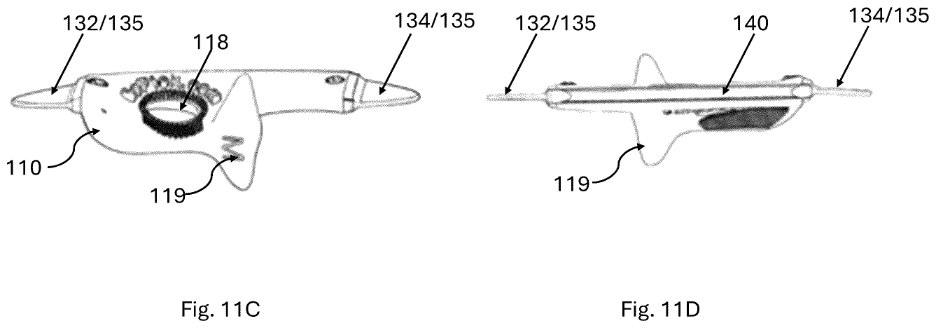

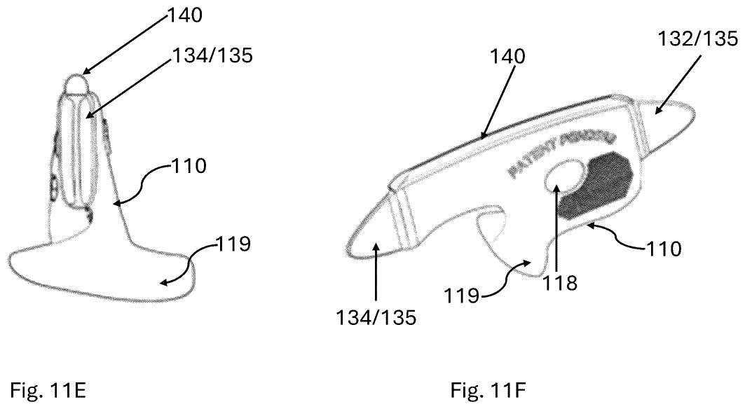

In some embodiments, the first interface 112 is configured to receive a mounting portion 137 of a first accessory 132. Referring to, for example, Figs. FIGS. 6B, 11A-F, 13A and 13B, in some embodiments the first accessory 132 is a playing tip 135. In some embodiments, the first interface 112 includes a first cavity or first socket 122 and the second interface 114 includes a second cavity or second socket 124. In some embodiments, the first socket 122 and the second socket are configured to receive a portion of the first and second accessory 132, 134, respectively. Referring to FIGS. 6A, 11A-11F, embodiments of the device 100 are shown where the first and second accessories 132, 134 are both playing tips 135. In some embodiments, the playing tips 135 are each different sizes. In some embodiments, the playing tips 135 are each the same size. In some embodiments, each of the playing tips 135 are identically shaped. In some embodiments, the playing tips 135 are not identical to each other. In some embodiments, the body 110 further includes a third interface or top interface 120 configured to at least partially accept a third accessory 140, such as a sound rail.

Overall, the body 110 is ergonomically configured to make it highly graspable and to maximize the contact area between the fingers 11-15 of the user and the surface area 116a, 116b of the body 110. The goal is both to minimize the short-term potential for slippage or loss of the body 110 during use. When one or more playing tips 135 are coupled to the body 110, the shape of the body 110 inhibits the long-term potential for fatigue, strain or injury due to what might otherwise be the over-heightened grasp of the user, as was previously described.

The body 110 may be formed as a single unitary component and comprised of various materials common to the trade, such as thermoplastics like nylon and Delrin. Various methods of manufacturing may be employed to make the body 110 such as injection molding or 3-d printing. In some embodiments, the body 110 may be formed in various sizes to accommodate users of various sizes. For example, the body 110 may be manufactured in small, medium and large dimensions to accommodate users with differently sized fingers/hands. Moreover, provisions for manufacturing custom versions of the device are envisioned, wherein the customer would supply relevant finger measurements when ordering, these most notably being the distances between the tip of the index finger and the distal interphalangeal crease, and the distance between the distal interphalangeal crease and the intermediate interphalangeal crease. In some embodiments, these measurements may be input into the base CAD model and used to make a custom sized 3-d print of the body 110, one that could also be made from a material stock chosen by the customer.

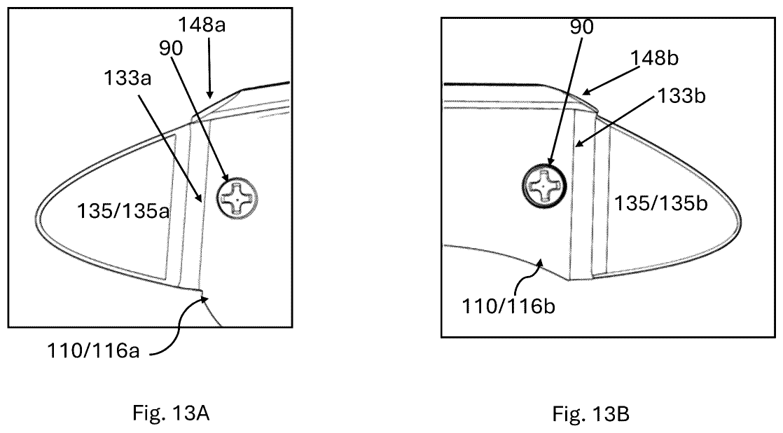

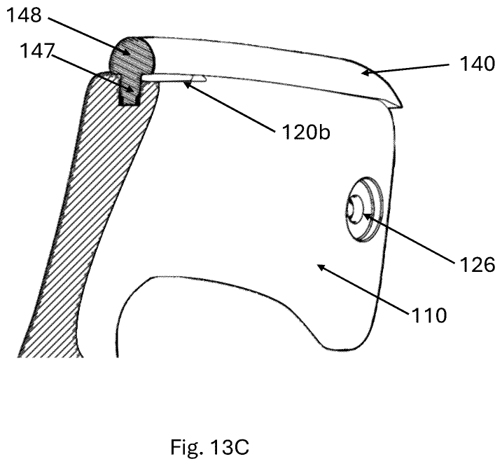

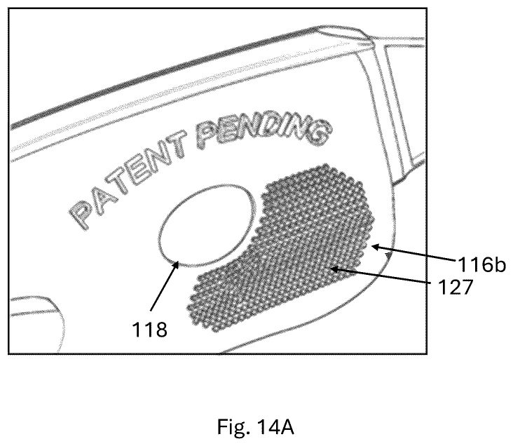

Referring in particular to FIGS. 6B, 11A-F, 13A and 13B, the accessories, such as playing tips 135 are separate components from the body 110. One embodiment of a playing tip 135 will be generally described, however, referring to FIG. 6C, many different embodiments of a playing tip are envisioned without departing from the disclosure. In some embodiments, each playing tip 135 comprises a body 136 including a mounting portion 137 and a tip portion or playing portion 138. In some embodiments, the mounting portion 137 is separated from the tip portion 138 by a transition portion 139. In some embodiments, the mounting portion 137 is at least partially received by the first and/or second interface 112, 114. In some embodiments, the transition portion 139 includes a shoulder. In some embodiments, the playing tip 135 may be inserted into the first socket 122 or the second socket 124 until the transition portion 139 contacts the body 110. In some embodiments, the mounting portion 137 includes a mounting member 137a to facilitate secure mounting of the playing tip 135 with the body 110. In some embodiments, the mounting member 137a comprises a bore extending through the mounting portion 137 and dimensioned to receive a fastener 90 (FIGS. 13A and 13B) to removably couple the body 110. This modular configuration allows for the playing tip 135 to be easily replaced, if broken or excessively worn, or to be substituted with another playing tip of different shape, size or material composition to suit the preferences of the user. In some embodiments, such as shown in FIG. 11A-F, 15C, 15D, and 16A-18C two playing tips 135 are coupled to the body 110 and may each be used individually to strike the strings of an instrument, meaning only one tip can be used at a time. In some embodiments, the playing tips 135 are formed as a single, unitary component and may be manufactured in a variety of sizes, shapes, thicknesses and material compositions. Referring to FIG. 6C, some users may desire to only use a single playing tip 135 and to not have a second playing tip 135 in the un-used socket, but also not to have it empty. As a solution, it is intended that a number of what we label here as “ornate playing tips” will be manufactured, which can be inserted in the said socket to provide an alternative. These are to be in the shapes of animal heads, geometric designs and so on, and can feature custom text.

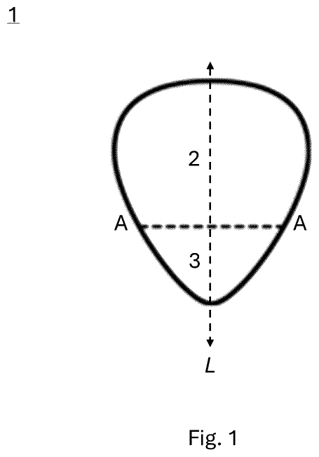

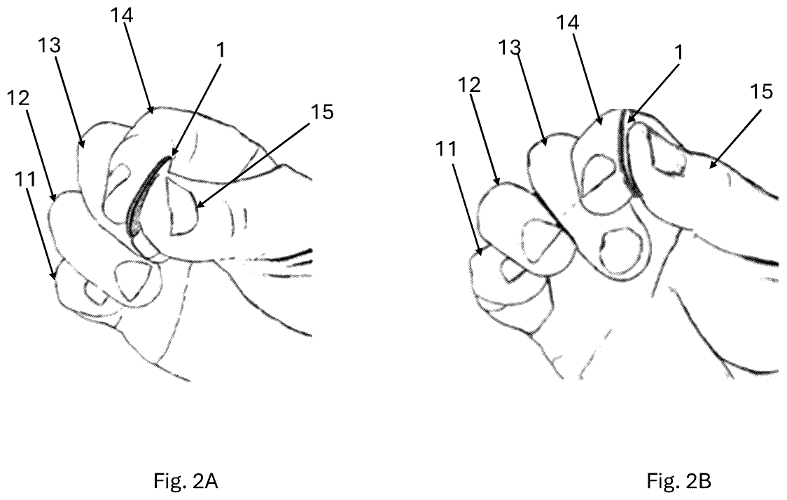

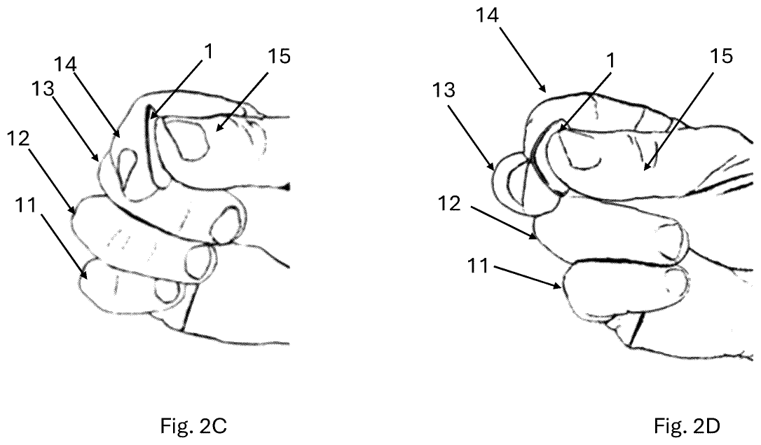

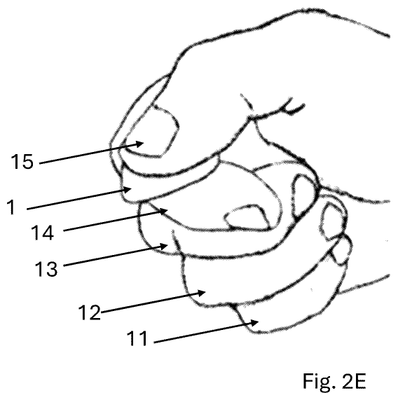

In some embodiments, the playing portion 138 comprises the portion of the playing tip 135 that interacts with the strings of an instrument. In the preferred embodiment here the playing portion resembles, and is functionally equivalent to, what we labelled earlier as the “striker” 3 (FIG. 1) of a conventional flat pick. In plane view, the playing portion 138 is roughly triangular in shape, with two of its edges being convex, and tapering gradually towards their distal ends to form a rounded point. As previously discussed, the third edge, opposite the rounded point, possesses a noticeably built up shoulder that serves as a structural transition portion 139 between the narrow strongly compressed two sides of the playing portion 138 and the wider, conjoined mounting portion 137.

In some embodiments, the mounting portions 137 and the interfaces 112, 114, specifically the first and second sockets 122, 124 are standardized, meaning that the same playing tips 135 may be interchangeably used with bodies 110 of different sizes. In addition, any playing tip 135 can be interchanged between sockets 122, 124 on the same body 110 or between different bodies of different sizes, which provides maximum flexibility for users. In some embodiments, the mounting portion 137 may create a friction fit with one of the first and second sockets 122, 124 such that a fastener 90 is not required. This allows for faster and tool-free change of playing tip 135. Given the modular nature, each component may be comprised of a different material. For example, the body 110 may be comprised of a different material than the playing tips 135 or the sound rail 140. In some embodiments, each of the two playing tips 135 may be comprised of a different material and/or be of a different size. For example, the body 110 may be comprised of a softer, more tactile material, such as hard rubber, to maximize grip-ability, while each of the playing tips 135 may be comprised of a different thermoplastic to cater to different needs for tip playability and the tone produced. This is a potential that is not matched by any prior art plectrums. Moreover, the playing tips 135 include an improved means of demarcating the said thicknesses on the body of the playing tips 135 using much larger text characters than those found on most picks, and an alphabetical labeling scheme.

### Front Gripping Position

To use either of the two playing tips 135, the user holds the body 110 with the specified playing tip 135 facing the same direction as the tips of the user's fingers. This means that the entire device 100 is rotated laterally 180 degrees when switching from playing one tip to the other. We use the terms “front gripping position” and “rear gripping position” from here forward to refer to the specific finger configuration with which a user holds the body 110 while using one or the other of the playing tips 135. We now examine these two gripping positions in detail.

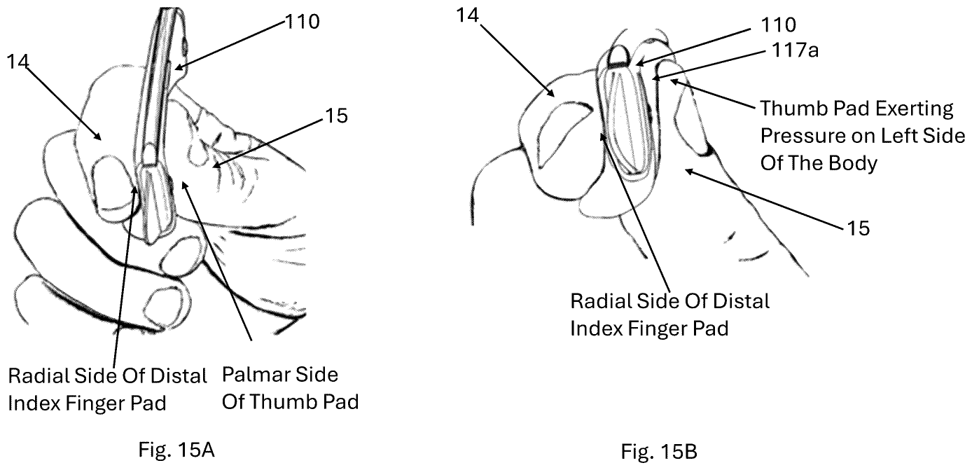

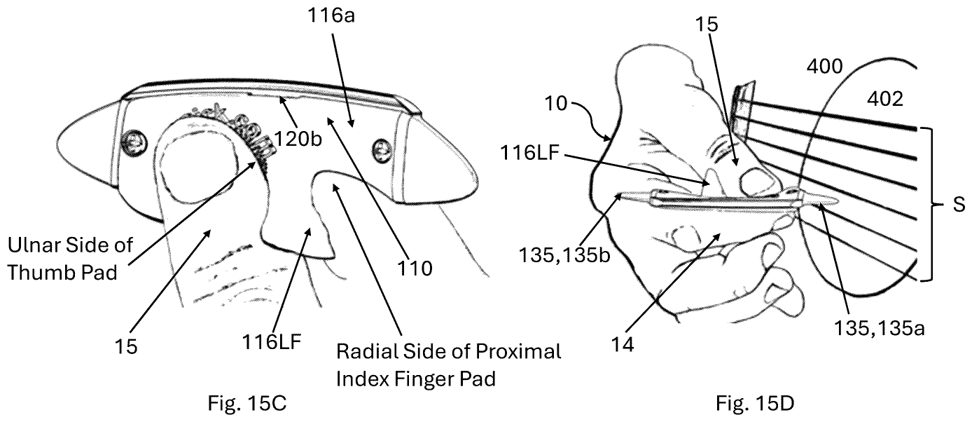

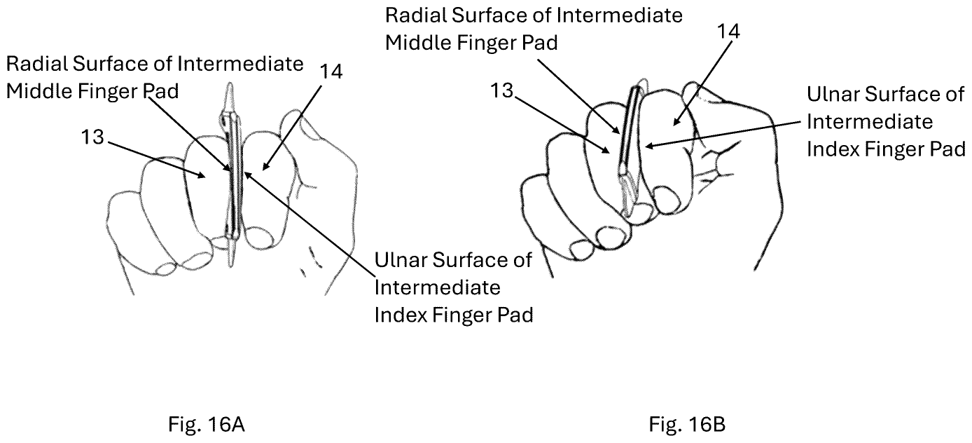

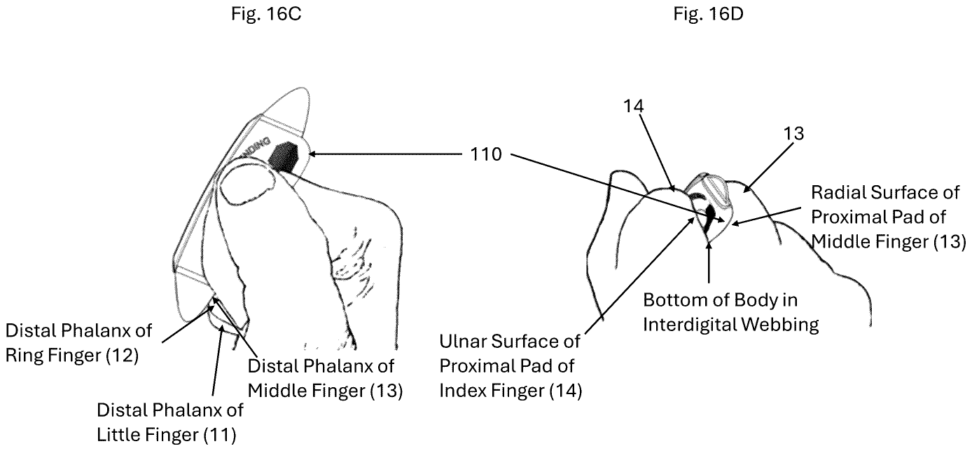

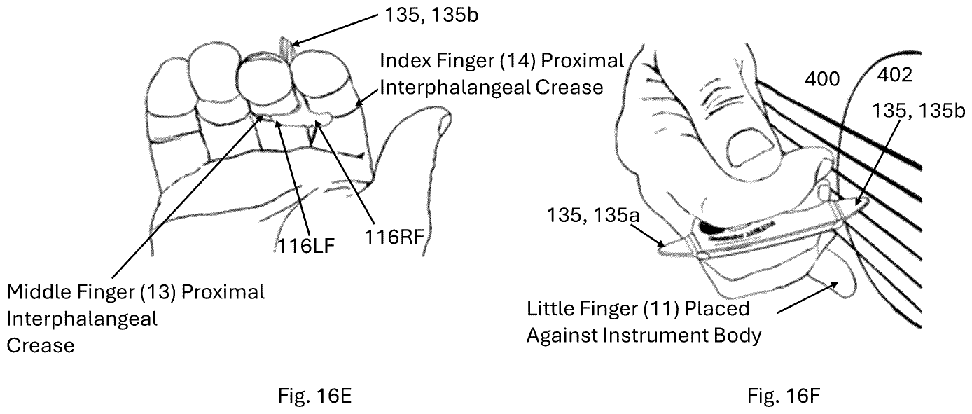

Referring to FIGS. 15A-16E, the front gripping position is shown where the hand 10 is oriented in a semi-pronated position, with the palm facing medially and toward the instrument strings S. The only fingers that come into contact with the plectrum are the musician's thumb 15 and index finger 14, using a finger configuration akin to the “angle position” used for holding conventional picks, as described earlier. Each of the two digits 14, 15 contacts closely with the ergonomically designed concave depression 117, neck, finger grip G, through-hole 118, Pad-Pads 127, 129 and raised branding lettering 128 on its respective side of the body 110, to create an overall situation of high static friction, to ensure that the user has a secure grip of the body 110 while in use. In some embodiments, the raised branding lettering 128 is the same on each side 116a, 116b of the body 110. In some embodiments, the raised branding lettering 128 is different on each side 116a, 116b of the body 110. In some embodiments, the raised branding lettering 128 may not comprise letters and/or numbers and may comprise one or more symbols, logos, or patterns.

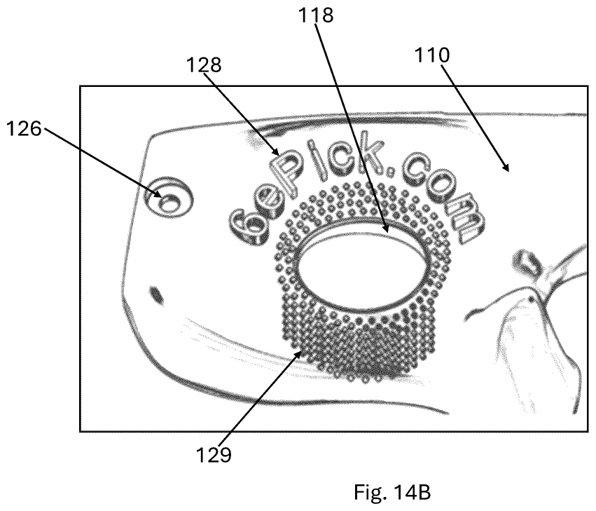

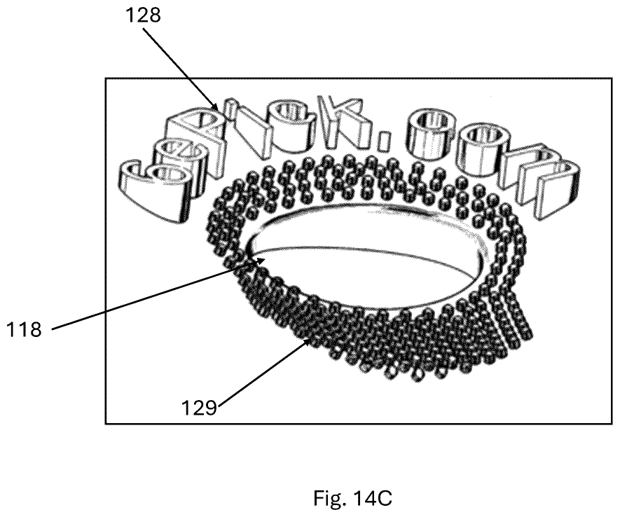

In some embodiments, such as shown in FIG. 15B, the palmar surface of the thumb 15 pad fits into the concave depression 117a, and the through-hole 118, on the left side of the body 110 with the said palmar surface contacting the Pad-Pads 129 and the raised branding lettering 128, the latter which forms a semi-circular wall or stop, around the top side of the through-hole 118 (FIG. 14C). The ulnar side of the thumb, in the area between its interphalangeal joint and the base of the fingernail, presses firmly against the outside edge and the underside of the left finger grip 116LF (FIG. 15C). This configuration greatly restricts the movement of the thumb 15.

Still referring to FIG. 15B, the radial side of the index finger, from the distal pad back to the proximal pad, comes into contact with the right side 116b of the body 110, at an approximate 45-degree angle. The distal pad fits into the deeper end of the concave depression 117b, and the through-hole located there, pressing up against the raised branding lettering present around the top side of the through-hole, as well as upon the Pad-Pads 127 located at the front and bottom sides of the through-hole 118 (FIGS. 14C and 15A). Next, the intermediate pad fits into the remainder of the said depression. Then, the palmar surface of the proximal pad butts up against the back side of the right finger grip 116RF (the grip being conjoined to the said concave depression). As such, the top surface of the right finger grip 116RF is pressed up into the proximal interphalangeal crease, thus affording a large amount of lateral stability to the plectrum. Finally, the bottom side of the neck touches along the radial surface of the proximal pad.

In the front gripping position, the thumb 15 shows little to no flexion in the interphalangeal joint. The index finger 14 exhibits approximately 30 degrees of flexion at the metacarpophalangeal joint, approximately 70 degrees of flexion at the proximal interphalangeal joint, and 30 degrees of flexion at the distal interphalangeal joint. The remaining three fingers 11, 12, 13 do not touch the body 110 at all and are flexed loosely in various manners depending on the individual user's preferences. The key aspect is that these other fingers 11, 12, 13 must be out of the way such that they do not interfere with the user's ability to direct the playing tip 135, 135a in the desired manner. The little finger 11 is sometimes placed, in a fully extended manner, against the body of the instrument 400 below the sound hole 402, as a means of stabilizing the playing hand (FIG. 15D).

### Rear Gripping Position

It is noted again that the rear gripping position is reached by rotating the body 110, 180 degrees laterally from the front gripping position. This rotation brings the rear playing tip 135b to face the instrument strings S. As such, the hand orientation remains the same as in the front gripping position, being semi-pronated with the palm facing medially and towards the instrument strings S. However, this position uses a different combination of two fingers: the index finger 14 and the middle finger 13. As discussed previously, the “three jaw chuck” gripping position uses these same two fingers, but it also employs the thumb 15. These two fingers are held closely together, with the body 110 snugly pressed between them. This situation presents a novel means of holding a plectrum, such as the body 110, and is not found in the prior art.

In some embodiments, the ulnar surface of the index finger 14 makes contact with the same side of the body 110 that the radial surface of this same digit made contact with the front gripping position, namely the right side 116b. The contact starts at the proximal end of the distal pad and extends along the remaining ulnar length of the digit. In particular, the proximal interphalangeal crease is wrapped over the right finger grip 116RF (FIG. 16E), which provides a very strong resistance to movement of the body 110 away from the palm, and also adds substantially to the lateral stabilization of it. Finally, the ulnar sides of the intermediate pad and the proximal pad abut the contour of the concave depression located on that side of the body 110, including pressing against the Pad-Pads 127 and the raised branding lettering 128 (FIG. 14C), greatly adding to the amount of frictional contact between the digit and the body 110.

Turning to the middle finger 14, the radial side of that digit is involved, with more or less the same general portions of it being in contact as was the case with the index finger. The contact is made on the same side of the body 110 that was in contact with the thumb pad in the front gripping position, that is, the left side 116a. The proximal interphalangeal crease is wrapped over the left finger grip 116LF (FIG. 16E), again providing great resistance to movement of the body in the direction away from the palm, and adding much lateral stabilization to it. Finally, the radial sides of both the intermediate and the proximal pads are in full frictional contact with the concave depression there (the thumb depression in the front holding position), with the Pad-Pads 129 and the raised branding lettering128 mostly being in contact with the proximal pad (FIG. 14C). All of this configuration detail adds up to create a large amount of frictional contact between the middle finger 13 and the left side of the main body 116a (FIGS. 16D and 16E).

It is critical to note that the bottom of the body 110 is nestled into the interdigital webbing between the index 14 and middle fingers 13 (see FIGS. 3 and 16D). This webbing acts as a cushion and stabilizer against the impact force when the playing tip 135 at the other, working end strikes an instrument string S. Overall, it assists in securing the body in the user's fingers.

The terminal section of the neck 116N of the body 110, with the attached rear playing tip 135b, emerges from between the index finger 14 and the middle finger 13, in the general area of their respective intermediate pads. It then curves and arches up over the dorsal surface of the distal phalanx of the middle finger, touching lightly on the radial side of the distal interphalangeal joint (FIG. 16B). From there, the neck continues out to the attachment point with the playing tip, the latter terminating in mid-air above the said distal phalanx of the middle finger. This positioning allows the user to direct the playing tip 135b to strike an instrument string S without the middle fingertip getting in the way. The neck 116N, to which the playing tip 135b is attached, is configured with respect to the remainder of the body 110 such that it aligns the sides of the playing tip 135b to be more or less parallel to the longitudinal direction of the instrument strings (FIG. 16F). This allows the user to easily engage an individual string S with one or the other of the flat sides of the playing tip 135b, as is the preferred technique when using a conventional playing tip.

In the rear gripping position, the thumb 15 is fully extended and more or less assumes the position it takes during the “key” gripping position, as previously described. That is, the palmar surface of the thumb 15 presses against the radial surface of the intermediate pad of the index finger 14 and sometimes onto the radial surface of the proximal interphalangeal crease, depending on the personal preference of the user.

The other four fingers 11-14 are nearly completely flexed at the distal interphalangeal and proximal interphalangeal joints, forming a fairly tight curl, with the body 110 being snugly pressed between the index and middle fingers 14, 13. While the user is playing, the primary movement consists of all four fingers moving in unison at the metacarpophalangeal joints with those joints extending and flexing as needed to direct the playing tip to different strings. One exception to this generalization occurs when some users prefer to place the little finger 11, fully extended, against the body 400 of the instrument below the sound hole 402 as a means of stabilizing the hand 10 while playing (FIG. 16F).

Overall, the highly ergonomic shape of the plectrum or body 110, in combination with the two finger grips 116RF, 116LF, the through-hole 118, the Pad-Pads 127, 129, and the raised branding lettering 128, creates a large amount of surface area in contact with the user's finger pads and interphalangeal creases, which ensures that the user experiences a very high level of static friction force when using either the front or the rear gripping position. This greatly lessens the probability of slippage or loss of the body 110 during use.

### Using the Top Edge of Plectrum Body As a Striking Surface: Sound Rail

As previously discussed, the body 110 is configured so that the user may engage multiple strings S at the same time using only the body 110 itself, by using, in general terms, the comparatively long and structurally robust top edge 115a of the body 110 to strike down upon the 12 o'clock position of the instrument strings S. The top edge 115a of the body 110 may be employed for this purpose when using either the front gripping position or the rear gripping position.

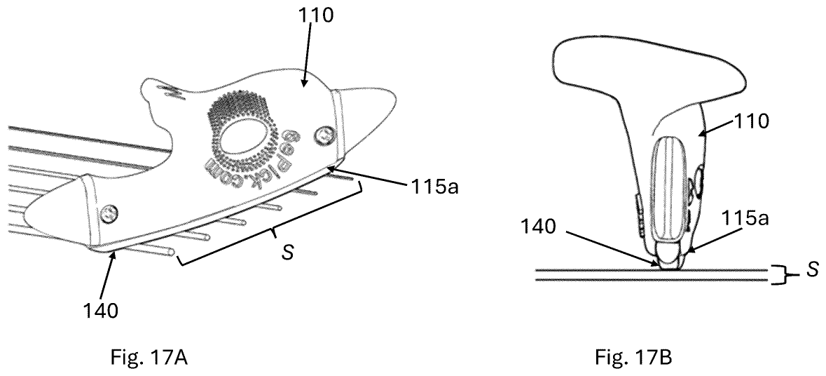

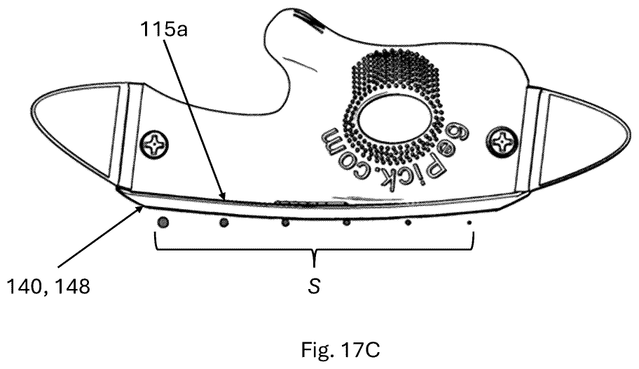

In some embodiments, the top edge 115a of the body 110 is slightly convexly curved (FIGS. 6A, 8A-D, 9A-F), and in some embodiments, is configured across its length dimension to be a bit longer than the distance between the first and sixth strings on a conventional six-string guitar (FIG. 17A). In some embodiments, the top edge 115a is configured with a broad flat surface across its width dimension. In some embodiments, the top edge 115a of the body 110 is relatively broad in comparison to the width of the sides of the body 110 below it. This configuration provides a robust surface for the mounting of an accessory 133. In some embodiments, the accessory 133 is a sound rail 140 configured to strike one or more instrument strings at the same time. In some embodiments, the sound rail 140 is configured to strike at least three strings at the same time. In some embodiments, the sound rail 140 enables the striking of instrument strings while inhibiting wear and/or damage to the top surface 115a.

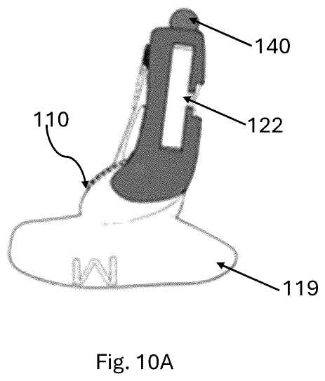

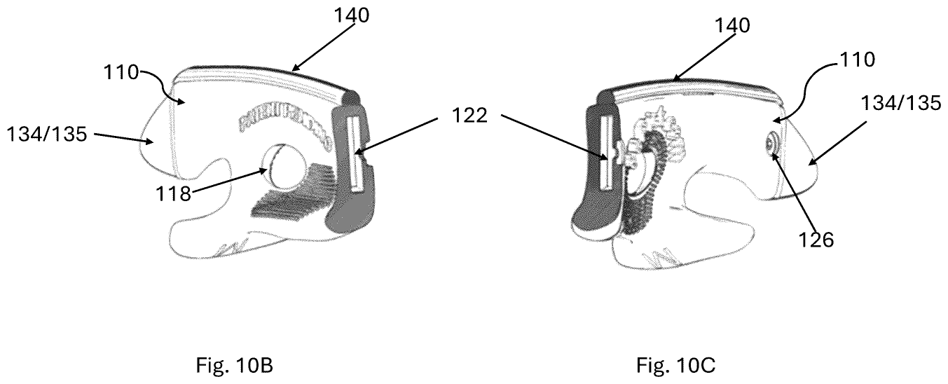

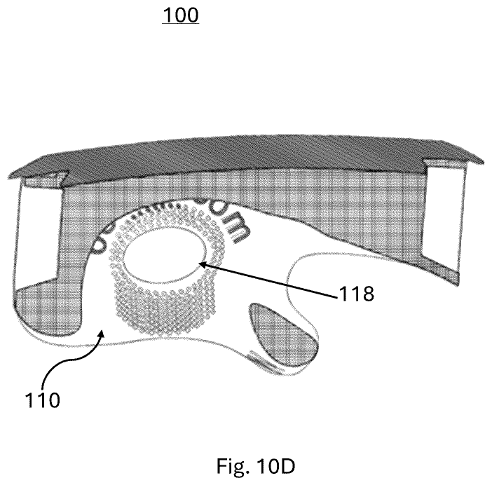

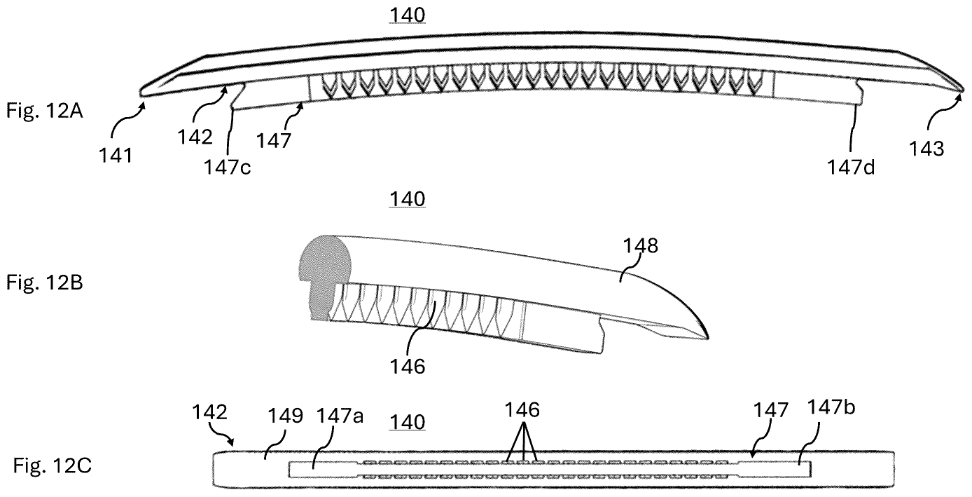

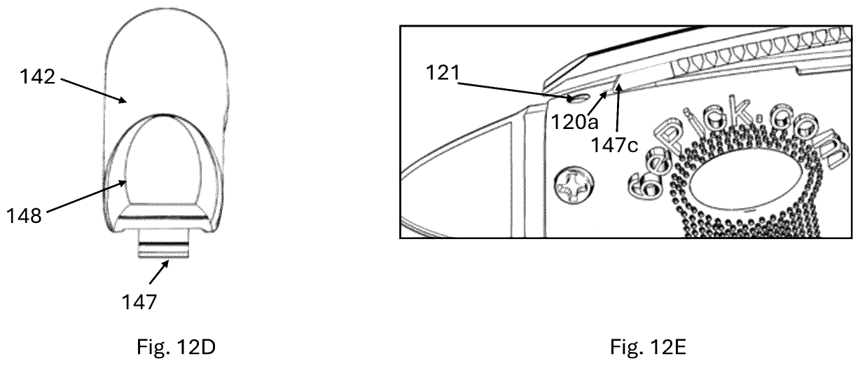

Referring, for example, to FIGS. 6A, 8B, 8C, 9C, 9D, in some embodiments, the top edge 115a of the body 110 defines an interface 120 that is configured to interact with the sound rail 140 to removably couple the sound rail 140 to the top edge 115a of the body 110. In some embodiments, the interface 120 comprises a narrow slot 120a extending approximately the length of the top edge 115a. Referring to FIG. 12A-C, in some embodiments, the sound rail 140 includes a rail body 142 extending from a first end 141 to a second end 143. In some embodiments, the rail body 142 includes a mounting portion 147 that is configured to be at least partially received by the interface 120 to removable coupled the sound rail 140 to the body 110. In some embodiments, the mounting portion 147 includes a plurality of coupling elements 146 that are configured to facilitate removable coupling of the sound rail 140 at the interface 120. In some embodiments, the plurality of coupling elements create a friction-fit between the sound rail 140 and the interface 120 of the body 110. In some embodiments, the sound rail 140 further includes a playing portion 148 configured to extend from the mounting portion 147. In some embodiments, the sound rail 140 comprises a rounded cross-section as is generally shown in FIG. 10A-C, 11E, 12B, and 13C. In some embodiments, the cross-section of the playing portion 148 is semi-cylindrically shaped and is approximately half the width of the top edge 115a. In some embodiments, the playing portion 148 mirrors the slightly convexly curve of the top edge 115a. In some embodiments, the playing portion 148 of the sound rail 140 is configured to provide a smooth, durable and rounded contact area for engagement with instrument strings.

In some embodiments, the playing portion defines a shoulder 149 which delimits the mounting portion 147 from the playing portion 148. In some embodiments, the mounting portion 147 comprises a tang that extends from the shoulder 149 and is about one-third of its width (FIG. 12C). In some embodiments, the mounting portion 147 includes a first coupler 147a positioned towards the first end 141 of the sound rail 140 and a second coupler 147b positioned towards the second end 143 of the sound rail 140. In some embodiments, the first and second couplers 147a, 147b are configured to be at least partially received by the interface 120 at the top edge 115a of the body 110. In some embodiments, the sound rail 140 is configured to be securely seated by friction fit into the slot 120a running across the top edge 115a of the body 110. In some embodiments, the plurality of coupling elements 126 comprise rows of small barbs on one or more sides of the mounting portion 147 that are configured to engage with the slot 120a to provide frictional resistance. In some embodiments, one end of the first coupler 147a comprises a sharp prong 147c that fits into a front end of the slot 120a. In some embodiments, the second coupler 147b includes a blunt prong 147d configured to fit into the rear end of the slot 120a. In some embodiments, such as shown in FIGS. 9C and 12E, a small circular depression 121 may be present on the top edge 115a of the body 110 to indicate the proper installation location of the sharp prong 147c. In some embodiments, installation of the sound rail 140 is accomplished by first inserting the sharp end of the tang 147c into the slot 120a and then flexing the body 142 of the sound rail 140 so that the blunt prong 147d can be partially inserted into the slot 120a whereupon the playing portion 148 of the sound rail 140 can then be pushed downward to firmly set both prongs into the slot 120a (FIG. 12E).

As previously described, in some embodiments, the mounting portion 147 of the sound rail 140 is configured to be removably attached to the body 110. In some embodiments, the mounting portion 147 may be easily pried out of the slot 120a using a tool, such as a screwdriver, or one's thumbnail. Referring to FIG. 13C, in some embodiments, the body 110 defines a groove 120b positioned along or proximate to the top edge 115a to at least partially receive a tool (e.g., a screwdriver) or a user's fingernail to assist in removal of the sound rail 140. In some embodiments, the mounting portion 147 of the sound rail 140 is shorter than the playing portion 148 as shown in FIGS. 12A and 12C, which enables the playing portion 148 to cantilever 148a, 148b over those areas of the top edge 115a where the slot 120a is not present and to continue outward to cover the two joints 133a, 133b where the playing tips 135 are removably attached to the body 110 as shown in FIGS. 13A and 13B. It is beneficial that these non-smooth joints are not exposed to the instrument strings when a musician uses the sound rail because they may produce unwanted sounds and possibly lead to the sound rail 140 being dislodged from the slot 120a upon unintended interaction with the strings. This would be especially true if a sliding or raking technique is employed to contact the sound rail 140 with the instrument strings.

In some embodiments, the sound rail 140 may be comprised of a flexible material, such as a plastic, rubber, a composite, or any combination thereof. In some embodiments, the sound rail 140 may be formed as a single, unitary component using 3-d printing or other techniques common in the field. As a further enhancement of the modular nature and customization potential of the plectrum body 110, the intention is to provide a plurality of sound rails 140, varying in material composition, to suit different playing styles and personal preferences for particular sounds, since sound rails 140 made of different materials produce different acoustic effects when brought into contact with the instrument strings. As noted above, the sound rail 140 is removably attached, so it is a relatively simple procedure to carry out this modular operation.

### Using the Sound Rail

As previously described, the sound rail 140 may be slightly convexly curved to match the contour of the underlying top edge 115a of the body 110. This has the important implication that if the user brings the sound rail downward at a 90 degree angle to strike lightly upon the tops of the instrument strings S, which themselves are not in a straight plane, but rather follow an upward pointing concave curve (due to the intentional radius built into the fretboard, and the bridge and saddle, of typical six string guitars), the sound rail 140 only comes into contact with two or three adjacent strings, the exact number depending upon the radius of the said guitar components (FIG. 17A-C). The identity of these two or three adjacent strings depends upon where the rail is brought down upon the string assembly.

If the user wishes to engage more than two or three strings at once, up to six strings, then three options present themselves. First, in some embodiments, the user may use a larger amount of force in the vertical downward striking of the string assembly, such that shortly after striking the initial strings, those strings flex downward, now exposing the tops of the other strings, which are then brought into contact with the downward-thrusting sound rail 140. In this scenario, of course, the strings S technically are not sounding simultaneously, but it is just a matter of milliseconds before all targeted strings are being struck. This is especially true if a considerable amount of force is being applied by the user.

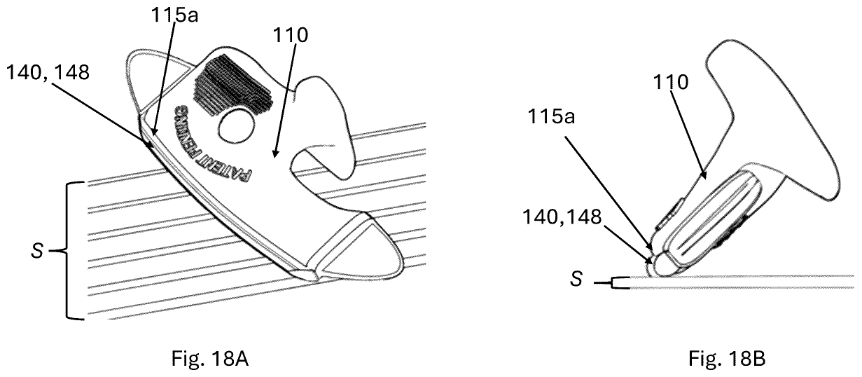

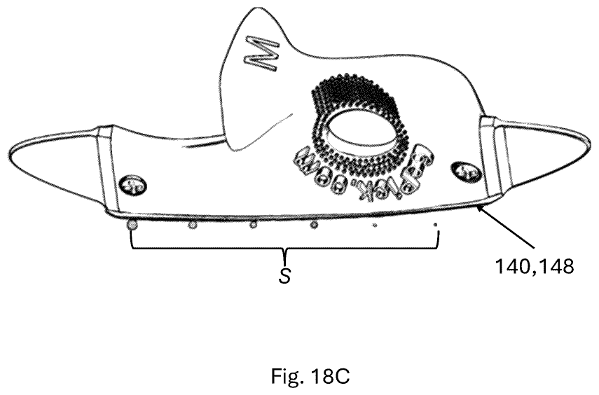

Alternatively, the user may angle the downward attack of the sound rail 140 to an approximate 45 degree angle to the string assembly, which works only with the front-end gripping position. At that angle, more strings S can be contacted initially due to the side of the sound rail 140 possessing less of a convexly curved shape than that of the top of the sound rail (FIG. 18A-C). This actually is an easier maneuver than using the 90 degree striking angle in this gripping position, since it requires less pronation of the forearm (as described in more detail below). The reason this maneuver cannot be performed when using the rear gripping position is that the dorsal surface of the medial phalanx of all four fingers (the said fingers being completely flexed into a loose fist) comes into contact with the string assembly at any angle less than approximately 90 degrees. It physically is not possible to turn the sound rail 140 at a 45 degree angle to the string assembly with the said portions of the fingers being so close to the strings.

In a third option, instead of striking forcibly, and vertically, downward on the string assembly, the user may gently push downward, initially engaging the middle strings, but soon thereafter contacting the other ones as the downward push continues. Notably, this first step occurs with no or minimal sound being generated. The downward pushing on the strings S continues up to the point where it is too uncomfortable or difficult to push any further, at which point the user may pull the sound rail rapidly upward and away from the strings S, thus releasing them and causing them to vibrate simultaneously and produce a musical sound. This same technique may be used to sound smaller groupings of the six strings S, most commonly, the four middle ones, the lower two or three, or the upper two or three strings, but to do so successfully requires much more targeted and careful direction of the sound rail 140 in order to contact the strings involved.

### Anatomical Details of Using the Sound Rail in Two Gripping Positions

The anatomical details present when the sound rail 140 is used in the two different gripping positions will now be described. In the front gripping position, the switch from using the playing tip 135 to using the sound rail 140 as a playing surface primarily involves a major forearm movement, with minor, if any, changes in the configuration of the fingers 11-15, hand 10, and wrist. In the normal tip-playing position, the forearm is semi-pronated, with the palm facing medially and the index finger 14 superior to the other fingers. In some embodiments, to use the sound rail 140, the forearm must pronate much further so that the palm faces laterally and the index finger 14 is inferior to the other fingers. This pronounced rotation of the forearm positions the sound rail 140 downward toward the instrument strings S, at an angle anywhere between 90 and 45 degrees to the strings, depending upon the user's preference. From here, the user may direct the sound rail 140 downward onto the 12 o'clock position of one or more of the instrument strings S, as described previously. This can be done in either a rubbing or raking fashion, a sliding fashion, or a direct hitting fashion, which can range from a gentle tap to a rapid strike applied with considerable force. Furthermore, all of these options can be applied anywhere along the length of the strings S, although various degrees of upper arm movement become necessary as the user strikes areas farther up the fretboard away from the sound hole 402.

Turning next to the rear gripping position, the switch from using the playing tip to using the sound rail 140 primarily involves changing the flexion of the four fingers 11-14 and the flexion of the wrist, with the thumb 15 remaining in a fully extended orientation. In the normal tip-playing position, the four fingers 11-14 are flexed into a loose fist, with the body 110 positioned between the index 14 and middle fingers 13. However, to use the sound rail 140, the fingers must tighten into a fully closed fist to hold the body 110 as securely as possible. Next, while maintaining constant pressure on the closed fist configuration, the user flexes their wrist sufficiently to align the top edge 115a of the body 110 above the instrument strings S at a more or less 90 degree angle to them. At this point, the sound rail 140 is brought down upon the instrument strings S, akin to how it is done using the front end position, that is, by using either the forceful strike technique or the gentle press-and-release technique described earlier.

Notably, however, a more pronounced “raking” technique is possible when using the sound rail 140 in the rear-end gripping position. For example, the hand 10 is orientated such that the end of the sound rail 140 closest to the playing tip 135 is positioned above one of the lower strings S. The said back end, including possibly some portion of the edge of the playing tip 135 located nearby, is then struck down upon that string S, and then rapidly and sequentially drawn across the top surface of each succeeding string S until they have all been hit. This is done using a raking action, by moving the four fingers 11-14 simultaneously from the closed fist configuration to one is which all of them are more or less fully extended, akin to the movement of the fingers when one shifts from a closed fist configuration to making a “stop” gesture, all the while keeping the body 110 firmly pressed between the index 14 and middle fingers 13.

As previously discussed, one prior art plectrum teaches an improvement similar to the sound rail described here, that being U.S. Pat. No. 5,419,228, entitled ‘Musical Instrument Pick with Multiple Playing Surfaces,’ by Garrett and Garrett. It discloses a plectrum body that features a “metal bar extending along the top of a conventionally shaped pick body.” The bar is rounded and used to perform “slide” and “finger tapping” techniques upon what we are labeling in our presentation as the 12 o'clock position of instrument strings. However, the disclosed sound rail 140 is much longer that those of the prior art and so is capable of interacting with up to six strings at a time. Moreover, the disclosed sound rail 140 is removably coupled to the body 110 of the plectrum, which is an improvement over the prior art. In addition, the user does not have to release or change their grip on the body 110 in any way in order to quickly and easily switch from using the playing tip 135 to using the sound rail 140. In contrast, prior to using the striking bar on the prior art plectrum, the user must release the grip on the body and turn the entire plectrum 180 degrees, and then re-grip it, which is awkward and time-consuming.

### Using the Body for Holding Other Small Tools

In some embodiments, the body 110 may be generally thought of as being a gripping device, or holder 100 for facilitating the use of small tools that ordinarily are held solely by some combination of one's fingers. In the previously discussed embodiments, the body 110, being used as a plectrum, acts as a holder for tools, such as playing tips 135 and the sound rail 140. However, in other embodiments, the body 110 may be configured to hold other, removably attached small tools. In the latter case, for example, one can envision a cylindrical, diamond-encrusted metal file, conjoined with a mounting portion similar to the mounting portion 147 of the sound rail 140, that could be inserted into the top edge slot 120a of the body 110, thus creating a “lateral” ergonomic handle for a tool that ordinarily has a handle on one of its ends.

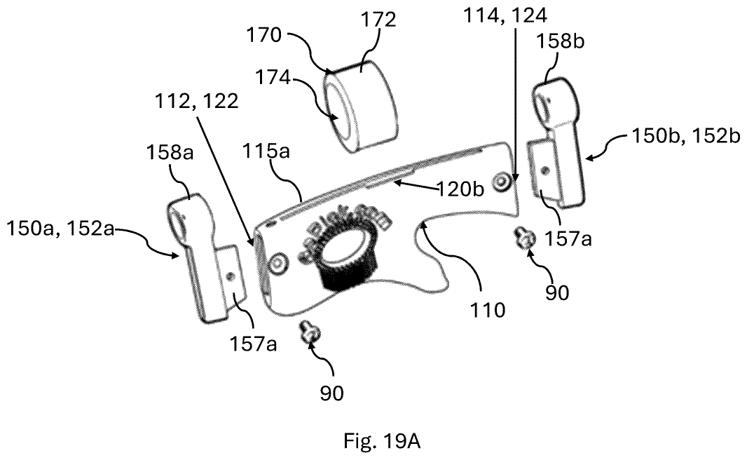

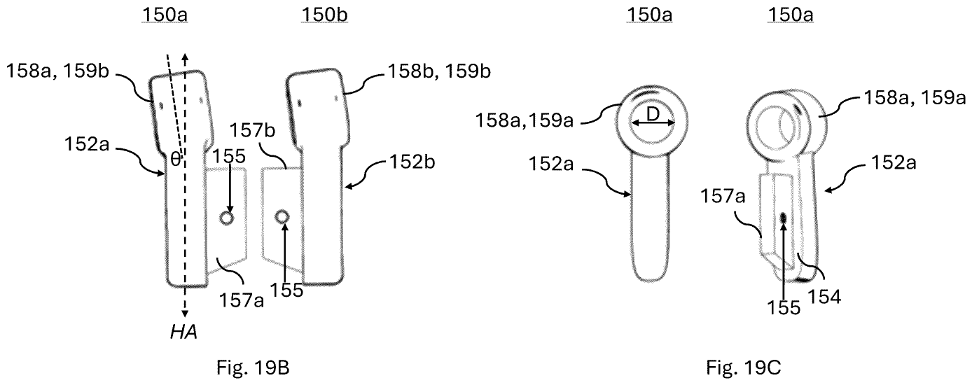

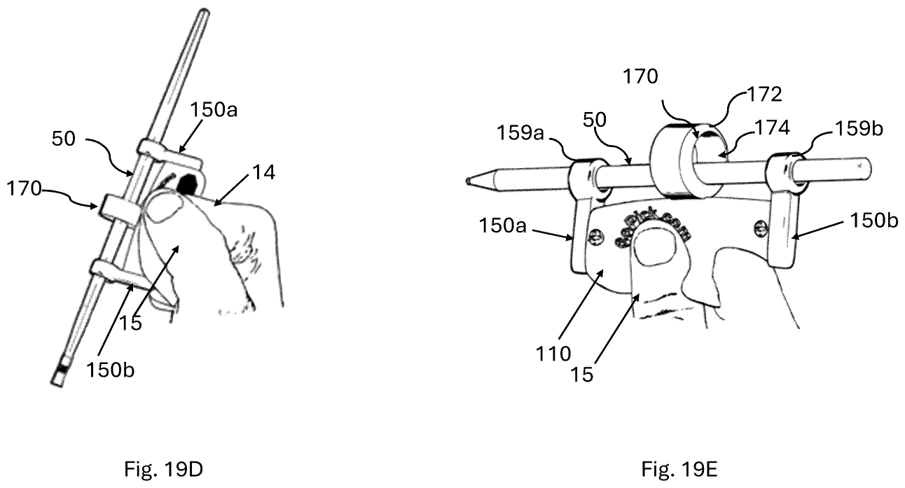

Referring to FIG. 19A-E, in some embodiments, first and second holders 150a, 150b are configured to removably couple first and second ends 111, 113 of the body 110. In some embodiments, the first holder 150a is configured to couple to the body 110 at the first interface 112 and the second holder 150b is configured to couple to the body 110 at the second interface 114. In some embodiments, the first holder 150a is configured to couple to the body 110 at the first socket 122 and the second holder 150b is configured to couple to the body 110 at the second socket 124. In some embodiments, the first and second holders 150a, 150b may be identical to each other. In some embodiments, the first and second holders 150a, 150b are different from each other.

In some embodiments, the holders 150a, 150b enable the body 110 to act as a handle extension for small tools. In some embodiments, the holders 150a, 150b enable the body 110 to act as a handle for tools with long, cylindrical handles, including, but not limited to, writing utensils, markers, artistry paint brushes, cylindrical files, and picks. This embodiment addresses a need for such handle extensions for those persons who experience difficulty in using such small tools due to grip-ability issues related to the design configuration or surface textures of such small tools, or due to finger, hand or wrist issues, such as missing or uncommonly shaped fingers, arthritis, carpel tunnel, or other such physical disorders. Beginning users of such tools may also benefit from this embodiment, for example, children learning to write with writing implements or learning to use a paint brush.

### Tool Holders

An embodiment of the holder 150a, 150b will now be described with reference to FIG. 19A-C. In some embodiments, each holder 150a, 150b includes a body 152a, 152b that includes a mounting portion 157a, 157b and a holding portion 158a, 158b. In some embodiments, the mounting portion 157a, 157b is configured to at least be partially received at the interface 112, 114 by the socket 122, 124. In some embodiments, the holding portion 158a, 158b includes a retainer 159a, 159c that is configured to retain a portion of a tool 50 (FIGS. 19D and 19E). In some embodiments, the mounting portion 157a, 157b may include a bore 155 be further secured to the body 110 via one or more fasteners 90 similar to embodiments of the playing tips 135 previously discussed. In some embodiments, the retainer is positioned at an angle θ relative to the axis HA of the holder body 152a, 152b. Accordingly, in this embodiment, the holders 150a, 150b are not interchangeable and will only function in their respective sockets 122, 124. In some embodiments, the angle is about 85°. In some embodiments, both retainers 159a, 159b are identical. In some embodiments, the retainers 159a, 159b are configured differently from each other. In some embodiments, at least one of the retainers 159a, 159b comprises a hollow cylinder. In some embodiments, the holders 150a, 150b include a shoulder 154 that separates the mounting portion 157a, 157b from the rest of the holder body 152a, 152b. In some embodiments, the shoulder 154 acts as a stop member to prevent over insertion of the holder 150a, 150b into the respective socket 122, 124.

Once the holders 150a, 150b are installed on the body 110, the retainers 159a, 159b extend substantially along parallel axes. This configuration enables secure retention of a tool 50. In some embodiments, the retainers 159a, 159b are configured to at least partially surround a portion of the tool 50 such that they may accept a portion of a small-diameter cylindrical handle, such as the paint brush (FIG. 19D) or pencil (FIG. 19E). In some embodiments, the tool 50 runs through the retainers 159a, 159b. In some embodiments, the diameter of the tool 50 might be slightly smaller than a diameter D or a dimension of the retainers 159a, 159b so that adequate static friction is present to keep the tool 50 in a desired position. However, sometimes the tool diameter is much smaller than the diameter D or dimension of the retainers 159a, 159b such that there would not be sufficient friction to keep the tool 50 secured in the retainers 159a, 159b during use.

In some embodiments, to accommodate smaller diameter tools 50, a securing member 170 may be provided. In some embodiments, the securing member 170 generally comprises a central bore 174 surrounded by a securing member wall 172. In some embodiments, the securing member 170 comprises an eccentric cross-section. In some embodiments, the securing member 170 comprises a height dimension that is just less than the length of the groove 120b located on the top edge 115a of the body 110. In some embodiments, the central bore 174 of the securing member 170 is sized to accommodate a range of small tool diameters. Since the securing member 170 is an eccentric hollow cylinder, the thickness of its wall 172 smoothly transitions around the perimeter, from a most narrow thickness to a most wide one, and then back around to the most narrow thickness. This configuration permits the securing member 170 to be used as a wedge, to lock in position those small tools that have a diameter or dimension that is appreciably less than a dimension of the tool holders 150a, 150b.

In some embodiments, a method for securing a tool 50 in the holding device 100 includes inserting one end of the tool 50 through a first retainer 159a of the first holder 150a. In some embodiments, the securing member 170 is placed around the perimeter of that end of the tool 50. In some embodiments, the tool 50 is further directed toward and inserted through the second retainer 159b of the second holder 150b to a desired positioning. At this point, two portions of the tool's handle are being loosely held by the retainers 159a, 159b of the holders 150a, 150b. This desired positioning, vis-a-vis the underlying body 110, determines how far the working end of the tool protrudes beyond the respective end of the body 110, this being a distance that the user establishes based upon personal preference. In some embodiments, the securing member 170 is slid along the tool 50 until it is positioned within the depression of the groove 120b on the top edge 115a of the body 110 and is then rotated in a first direction until a thickness of the wall 172 is reached that forces the tool handle to become wedged against the retainers 159a, 159b (FIGS. 19D and 19E). The user may then adjust the amount of rotation to customize how tightly the tool 50 is being held in position. To loosen the tool 50 from the tool holders, one simply rotates the securing member 170 in a second direction that is different than the first direction.

The disclosed embodiments of holders 150a, 150b are envisioned to accommodate many different tools, across their inherent wide range of tool diameters. Accordingly, the retainers 159a, 159b may be manufactured in a number of different configurations to accommodate a given range of small tool diameters. For example, one could imagine a set of tool holder sizes consisting of 6 mm, 8.2 mm, 10.25 mm and 12.3 mm (these sizes being based upon the diameters of very common, branded tools, such as Bic pens, X-acto knives and Sharpie markers), such that the smallest diameter tools would be suitable for size 6 mm, while tools with a diameter just beyond 6 mm and ranging up to 8.2 mm would be suitable for the next size of tool holder, and so on.

### Gripping Positions of Tool Holder Embodiment

In some embodiments, the tool 50 may be loaded into the holders 150a, 150b such that its working end is either at the front end 111, or the rear end 113, of the body 110 (FIGS. 19D and 19E). Accordingly, the person using the embodiment may employ either a “front gripping position”, or a “rear gripping position”, the details of which we need not elaborate any further here since these positions are the same ones that we labeled and thoroughly described previously regarding previous embodiments of the body 110 configured as a plectrum. We can highlight, however, the advantage that this ability to use the rear gripping position might impart upon the user, since this position uses the index finger 14 and the middle finger 13 to grasp the body 110, a combination of fingers that is rarely employed to grip the small tools for which this embodiment is intended, but one which might be beneficial to persons who suffer from problems with one or more of their fingers and/or one or more of their thumbs.

### “Front” and “Rear” Body Embodiments

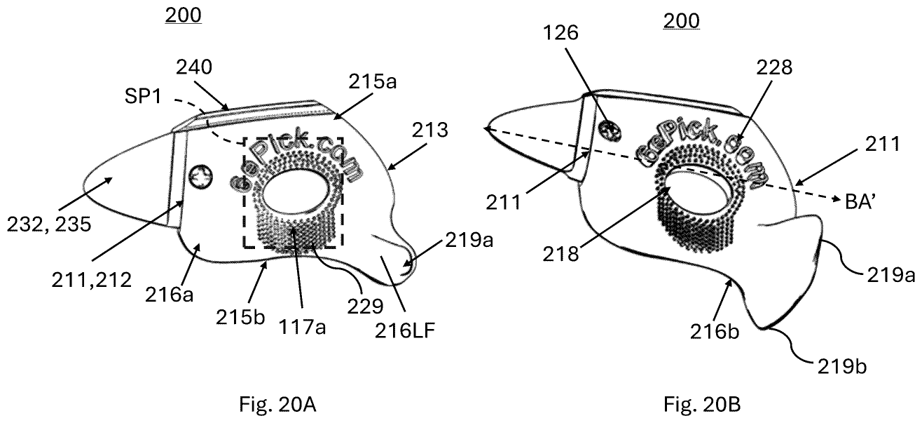

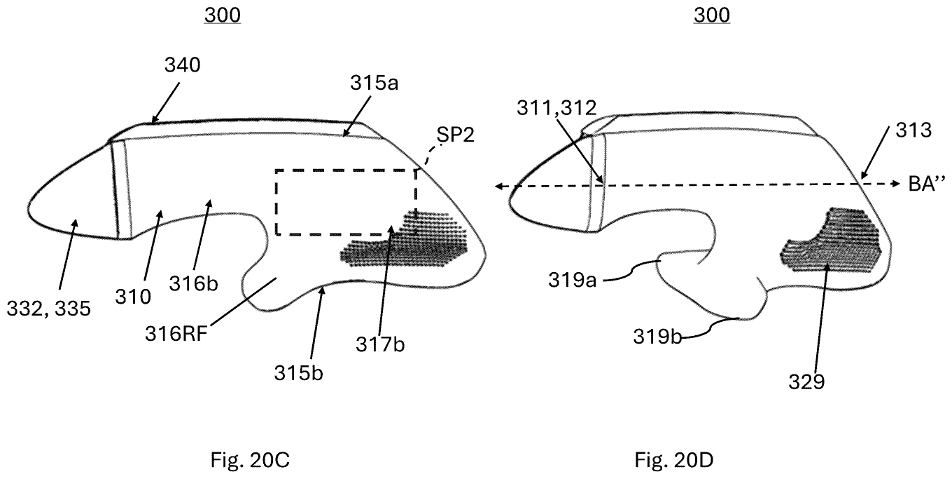

While previously discussed embodiments of the holding/plectrum device 100 have been configured to couple to accessories 132, 134 at the first end 111 and an opposing second end 113, it is envisioned, for examples in FIGS. 20A and 20B, that other embodiments of the device 200 comprise a body 210 that is essentially comprised of a front or first end portion of previously discussed embodiments of the body 110. In some embodiments, the body 210 extends along a body axis BA′ from a first end 211 to a second end 213. In some embodiments, the body 210 exhibits a very organic shape, with many curves and undulations that give it a unique and distinctive aesthetic. In some embodiments, the body 210 comprises an asymmetric structure and ergonomic shape. In some embodiments, the body 210 has a first side surface 216a defining a first surface portion SP1 and an opposing second side surface 216b. In some embodiments, the second side surface includes a second surface portion. Certain features will now be discussed in relation to the first side surface 216a, however it is envisioned that, in some embodiments, the second side surface 216b includes similar, if not identical features. In some embodiments, the second side includes similar features as embodiments of the second side 116b previously described. In some embodiments, the body 210 is a truncated version of embodiments of the body 110 previously discussed.

In some embodiments, the body 210 is laterally compressed at the first surface portion SP1. Accordingly, the thickness of the body 210 may vary between the first end 211 and the second end 213 and may be thinnest towards the first surface portion SP1 of the body 210. In some embodiments, the body 210 comprises a top edge 215a and a bottom edge 215b. Still referring to FIGS. 20A and 20B, in some embodiments, the body 210 features a complex curved surface, with at least one major concave depression 217. In some embodiments, the body 210 defines a through-hole or bore 218 located in the concave depression 217a. In some embodiments, the through-hole or bore 218 extends to a concave surface on the opposing second side of the body 210. In some embodiments, the depression 217a is shaped to closely match the outside contour of the respective digit pad(s) that engage with it, and each depression also has raised branding lettering 228 and patterns of raised dots 229 (Pad-Pads), resulting in an even greater amount of contact surface. In some embodiments, the Pad-Pads 229 may be formed on contoured surfaces of the body 210 to further promote easy and comfortable gripping of the body 210 by the use. In some embodiments, the body 210 is ergonomically configured similar to other embodiments previously described so as to receive the surfaces of the finger pads that come into contact with it. In some embodiments, each side surface 216a, 216b includes a convex protuberance 219a, 219b that extends perpendicularly from the bottom edge 215b. In some embodiments, the two protuberances 219a, 219b conjoin at their shared medial edges to form an overall shape suggestive of the ventral fins of a fish. This shape is ergonomically configured to function as two conjoined “finger grips,” i.e., the right finger grip and the left finger grip 216LF which, in combination with at least some of the other above-described features of the two side surfaces 216a, 216b, ensure that the body 210 may be held snugly and securely by the user so that it comfortably contacts with the fingers 11-15 (FIG. 3) of the user. In some embodiments, the right finger grip and the left finger grip 216LF are similar to those described and shown in previously discussed embodiments.

In some embodiments, the first end 211 includes a first interface 212 that may be similar to interfaces of previously discussed embodiments. In some embodiments, the first interface includes a first socket configured to at least partially receive an accessory, 232, such as a playing tip 235, in a similar manner as in previously discussed embodiments. In some embodiments, the body 210 further comprises mounting elements 226 configured to aid in removable coupling the accessory 232 to the body 210. Finally, the presence of the two protrusions 219a, 219b with corresponding finger grips add a tremendous amount of additional surface contact area, primarily in portions of the user's finger pads that other holding devices 200 do not touch at all. All of this contributes to a greatly improved holding device 200 with regard to the amount of potential contact surface between the main body 210 and the pad areas of the user's relevant digits.

In some embodiments, the body 210 includes a top interface at the top surface 215a. In some embodiments, the top interface is similar to the top interface 120 in previously discussed embodiments and is configured to at least partially accept a sound rail 240. In some embodiments, the sound rail 240 has many, if not all of the same components as embodiments of the sound rail 140 previously discussed. In some embodiments, the sound rail 240 is generally shorter than embodiments of the sound rail 140 previously described. In some embodiments, the holding device 200, when configured as a plectrum with a playing tip 235, is specifically structured for a front gripping position as previously described.

Referring to FIGS. 20C and 20D, another embodiment of the holding device 300 comprises a body 310 that is essentially comprised of a rear or second end portion of previously discussed embodiments of the body 110. In some embodiments, the body 310 extends along a body axis BA″ from a first end 311 to a second end 313. In some embodiments, the body 310 exhibits a very organic shape, with many curves and undulations that give it a unique and distinctive aesthetic. In some embodiments, the body 310 comprises an asymmetric structure and ergonomic shape. In some embodiments, the body 310 has a first side surface and a second side surface 316b. Certain features will now be discussed in relation to the second side surface 316b, however it is envisioned that, in some embodiments, the first side surface includes similar, if not identical features. In some embodiments, the second side surface 316b defines a second surface portion SP2. In some embodiments, the first side of the body 310 includes similar features as embodiments of the first side 116a previously described. In some embodiments, the body 310 is a truncated version of embodiments of the body 110 previously discussed.

In some embodiments, the body 310 is laterally compressed at the second surface portion SP2. Accordingly, the thickness of the body 310 may vary between the first end 311 and the second end 313 and may be thinnest towards the second surface portion SP2 of the body 310. In some embodiments, the body 310 comprises a top edge 315a and a bottom edge 315b. Still referring to FIGS. 20C and 20D, in some embodiments, the body 310 features a complex curved surface, with at least one major concave depression 317a located at least partially within the second surface portion SP2. In some embodiments, the depression 317b is shaped to closely match the outside contour of the respective digit pad(s) that engage with it. In some embodiments, the depression 317b also has raised branding lettering and patterns of raised dots 329 (Pad-Pads), resulting in an even greater amount of contact surface. In some embodiments, the Pad-Pads 229 may be formed on contoured surfaces of the body 310 to further promote easy and comfortable gripping of the body 310 by the use. In some embodiments, the body 310 is ergonomically configured similar to other embodiments previously described so as to receive the surfaces of the finger pads that come into contact with it. In some embodiments, each side surface 316b includes a convex protuberance 319a, 319b that extends perpendicularly from the bottom edge 215b. In some embodiments, the two protuberances 219a, 219b conjoin at their shared medial edges to form an overall shape suggestive of the ventral fins of a fish. This shape is ergonomically configured to function as two conjoined “finger grips,” i.e., the right finger grip 316RF and the left finger grip which, in combination with at least some of the other above-described features of the side surfaces 316b, ensure that the body 310 may be held snugly and securely by the user so that it comfortably contacts with the fingers 11-15 (FIG. 3) of the user. In some embodiments, the right finger grip 316RF and the left finger grip are similar to those described and shown in previously discussed embodiments.

In some embodiments, the first end 311 includes a first interface 312 that may be similar to interfaces of previously discussed embodiments. In some embodiments, the first interface includes a first socket configured to at least partially receive an accessory, 332, such as a playing tip 335, in a similar manner as in previously discussed embodiments. In some embodiments, the body 310 further comprises mounting elements configured to aid in removable coupling the accessory 332 to the body 310. Finally, the presence of the two protrusions 219a, 219b with corresponding finger grips add a tremendous amount of additional surface contact area, primarily in portions of the user's finger pads that other holding devices 300 do not touch at all. All of this contributes to a greatly improved holding device 300 with regard to the amount of potential contact surface between the main body 310 and the pad areas of the user's relevant digits.

In some embodiments, the body 310 includes a top interface at the top surface 315a. In some embodiments, the top interface is similar to the top interface 120 in previously discussed embodiments and is configured to at least partially accept a sound rail 340. In some embodiments, the sound rail 340 has many, if not all of the same components as embodiments of the sound rail 140 previously discussed. In some embodiments, the sound rail 340 may be shorter than embodiments of the sound rail 140 previously described. In some embodiments, the holding device 300, when configured as a plectrum with a playing tip 335, is specifically structured for a rear gripping position as previously described

While the present invention has been particularly shown and described with reference to certain exemplary embodiments, it will be understood by one skilled in the art that various changes in detail may be effected therein without departing from the spirit and scope of the invention that can be supported by the written description and drawings. Further, where exemplary embodiments are described with reference to a certain number of elements, it will be understood that the exemplary embodiments can be practiced utilizing either less than or more than the certain number of elements.

1. A holding device comprising:
a body extending from a first body end to a second body end, the body comprising,
a first interface at the first body end,
a top edge and an opposing bottom edge,
a first body side bounded by the first interface, the second end, the top edge, and the bottom edge, wherein the first body side includes a first surface portion,
a second body side opposing the first body side and bounded by the first interface, the second end, the top edge and the bottom edge, wherein the second body side includes a second surface portion,
a depression defined at each of the first and second surface portions,
a finger grip extending between the first body side and the second body side, wherein the finger grip is positioned towards the bottom edge, and
wherein the first interface is configured to removably couple to a first accessory,
wherein the depression and finger grip are configured to facilitate gripping of the body by a user's hand to securely operate the first accessory.

2. The holding device of claim 1, wherein the first interface defines a cavity configured to accept a portion of the first accessory.

3. The holding device of claim 2, wherein the second end comprises a second interface defining a cavity configured to accept a portion of a second accessory.

4. The holding device of claim 1, wherein the first accessory is a playing tip configured to play individual strings on a musical instrument.

5. The holding device of claim 3, wherein the top edge of the body further defines a third interface configured to removably couple to a third accessory, wherein the top edge defines a groove configured to at least partially accept a tool or a user's fingernail to assist in removal of the third accessory from the third interface.

6. The holding device of claim 5, wherein the third accessory comprises a sound rail configured to play multiple strings of a musical instrument at the same time.

7. The holding device of claim 1, further comprising a plurality of raised surface features positioned in at least one of: (i) the depression on the first side surface; or the depression on the second side surface, wherein the plurality of raise surface features are configured to engage one or more fingers of a user to increase friction between the one or more fingers and the body.

8. The holding device of claim 3, wherein at least one of the first accessory and the second accessory is a holder comprising a retainer configured to at least partially retain a portion of a tool.

9. The holding device of claim 1, wherein the top edge defines a groove positioned between the first and second ends of the body.

10. A holding assembly comprising:
a body extending from a first body end to a second body end, the body comprising,
a first interface at the first body end,
a second interface at the second body end,
a top edge comprising a groove extending along a portion of the top edge,
a first body side bounded by the first interface, the second interface, and the top edge,
a second body side opposing the first body side and bounded by the first interface,
the second interface, and the top edge,
a bore extending between the first body side and the second body side,
a depression at least partially surrounding the bore,
a finger grip extending between the first body side and the second body side, and
wherein the finger grip positioned away from the top edge;
a first holder configured to be removably coupled to the first interface, wherein the first holder comprises a first retainer configured to removably engage a first portion of a tool;
a second holder configured to be removably coupled to the second interface, wherein the second holder comprises a second retainer configured to engage a second portion of the tool,
wherein the depression and finger grip are configured to facilitate gripping of the body by a user's hand to securely operate the tool.

11. The holding assembly of claim 10, further comprising a securing member configured to be positioned in the groove of the top edge.

12. The holding assembly of claim 11, wherein the securing member comprises:
an outer wall defining a central bore and comprising a varying thickness; and
an eccentric cross-section.

13. The holding assembly of claim 12, wherein the securing member is configured to retain a third portion of the tool within the central bore.

14. The holding assembly of claim 13, wherein the securing member is configured to wedge the first portion of the tool against the first retainer and the second portion of the tool against the second retainer.

15. The holding assembly of claim 10, wherein the first interface defines a cavity configured to accept a portion of the first holder.

16. The holding assembly of claim 15, wherein the second interface comprises a cavity configured to accept a portion of the second holder.

17. The holding assembly of claim 10, wherein the tool comprises a writing utensil.

18. A method for securing a tool in a holding device, comprising:
providing a body extending from a first body end to a second body end, the body comprising,
a first interface at the first body end,
a second interface at the second body end,
a top edge comprising a groove extending along a portion of the top edge,
a first body side bounded by the first interface, the second interface, and the top edge,
a second body side opposing the first body side and bounded by the first interface,
the second interface, and the top edge,
a bore extending between the first body side and the second body side,
a depression at least partially surrounding the bore,
a finger grip extending between the first body side and the second body side, and
wherein the finger grip positioned away from the top edge,
a first holder configured to be removably coupled to the first interface, wherein the first holder comprises a first retainer configured to removably engage a first portion of a tool;
a second holder configured to be removably coupled to the second interface, wherein the second holder comprises a second retainer configured to engage a second portion of the tool, and
inserting one end of the tool through first and second retainer;
placing a securing member around a third portion of the tool such that the securing member is positioned in the groove of the top edge between the first and second holders;
rotating the securing member in a first direction relative to the body, wherein said rotation in the first direction wedges the first portion of the tool against the first retainer and wedges the second portion of the tool against the second retainer; and
gripping the body using the depression and finger grip to securely operate the tool.

19. The method of claim 18, further comprising structuring the securing member to comprise:
an outer wall defining a central bore and comprising a varying thickness; and
an eccentric cross-section.

20. The method of claim 18, further comprising loosening the tool by rotating the securing member in a second direction relative to the body, wherein the second direction is different from the first direction.
